(19) United States
(12) Patent Application Publication
(10) Pub. No.: US 2024/0169635 A1
(43) Pub. Date: May 23, 2024

(54) Systems and Methods for Anatomically-Driven 3D Facial Animation

(71) Applicant: Unity Technologies SF, San Francisco, CA (US)

(72) Inventors: Karan Singh, Toronto (CA); Byungkuk Choi, Wellington (NZ)

(21) Appl. No.: 18/058,687

(22) Filed: Nov. 23, 2022

(51) Int. Cl. G06T 13/40; G06T 11/60; G06T 17/20; G06V 10/82; G06V 40/16; G06V 40/18

(52) U.S. Cl. CPC G06T 13/40; G06T 11/60; G06T 17/20; G06V 10/82; G06V 40/171; G06V 40/174; G06V 40/18

(57) ABSTRACT

Embodiments described herein provide a three-dimensional (3D) facial processing system that can be used for animator-centric and anatomically-driven 3D facial modeling, animation and transfer. Specifically, a collection of muscle fiber curves may be considered as an anatomic basis, whose contraction and relaxation are defined as a fine-grained parameterization of human facial expression. An end-to-end modular deformation architecture may then be built using this representation to implemtn automatic optimization of the parameters of a specific face from high-quality dynamic facial scans; face animation driven by performance capture, keyframes, or dynamic simulation; interactive and direct manipulation of facial expression; and animation transfer from an actor to a character.

### FIELD

The present disclosure generally relates to tools for generating computer-generated imagery. The disclosure relates more particularly to apparatus and techniques for anatomically-driven 3D facial animation.

### BACKGROUND

Many industries generate or use computer-generated imagery, such as images or video sequences. The computer-generated imagery might include computer-animated characters that are based on live actors. For example, a feature film creator might want to generate a computer-animated character having facial expressions, movements, behaviors, etc. of a live actor, human or otherwise. It might be possible to have an animator specify, in detail, a surface of the live actor's body, but that can be difficult when dealing with facial expressions and movements of the live actor, as there are many variables, and may differ from actor to actor.

Existing animation systems often rely on the Facial Action Coding System (FACS), which is a popular baseline representation for facial animation. While FACS has allowed a level of standardization and interoperability across facial rigs, FACS was designed from a psychological standpoint to capture voluntary, distinguishable snapshots of facial expression, and has clear limitations when applied to computer animation. For exampel, the FACS Action Units (AUs) have several issues: (i) anatomic fidelity (AUs that combine the action of multiple facial muscles or do not involve facial muscles at all), (ii) localization and animation control (AUs that can be redundant, opposing in action, strongly co-related, or mutually exclusive), and (iii) facial deformation (AUs only approximate the complex shape deformations of a hinged jaw and flexible lips). In practice, animators often need to address these limitations ad-hoc and, as needed, augment FACS with large, unwieldy instances of specific and corrective deformers,

Therefore, there is a need for an efficient and accurate facial animation system.

### REFERENCE

[Lewis] Lewis et al., “Practice and Theory of Blendshape Facial Models”, Eurographics 2014—State of the Art Reports (2014).

[Li] Tianye Li, Timo Bolkart, Michael J. Black, Hao Li, and Javier Romero, “Learning a Model of Facial Shape and Expression from 4D Scans”, ACM Trans. Graph. 36 (2017)

### SUMMARY

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of the methods, as defined in the claims, is provided in the following written description of various embodiments of the disclosure and illustrated in the accompanying drawings.

Embodiments described herein provide systems and methods for facial animation of a character face using actor data captured from a human actor. Data associated with a plurality of facial scans of an actor over a first plurality of facial expression poses may be received. The system may compute, from the received data, a plurality of strain values corresponding to a plurality of facial muscle fiber curves given the first plurality of facial expression poses. An autoencoder may encode the plurality of strain values into a strain vector. A fully connected layer representing a strain-to-skin deformation matrix may transform the strain vector to a skin expression. An actor mesh may then be generated based on the skin expression, the strain vector and corresponding strain-to-skin deformation data. A neural network based shape transfer model is then trained for transferring the actor mesh to a character mesh using a dataset comprising the plurality of strain values and/or the strain vector, the skin expression corresponding to the actor and character skin expressions. The trained neural network based shape transfer model may then be used to generate, using the character mesh, an animated character facial expression pose from the strain vector corresponding to an actor facial expression pose.

In one implementation, the plurality of strain values may be divided into a first portion of strain values corresponding to a lower region on an actor face and a second portion of strain values corresponding to an upper region on the actor face. A first autoencoder may encode the first portion of strain values into a first strain vector, and a second autoencoder may encode the second portion of strain values into a second strain vector. The first strain vector and the second strain vector are concatenated into the strain vector.

In one implementation, a pose vector corresponding to jaw and eyeball control corresponding to the strain vector may be transformed to a vector containing concatenated elements of an eyeball transformation matrix and a jaw transformation matrix.

In one implementation, the neural network based shape transfer model is trained by updating model weights corresponding to eye and jaw regions and deformation matrices based on a cost function computed from a ground truth mesh, a rest-pose mesh, joint locations, and a pose vector; updating model weights further based on pose correction blendshapes; updating the strain-to-skin deformation matrix based on a loss computed from the rest-pose mesh and the actor mesh; and training the autoencoder by enforcing the autoencoder to preserve a rest-pose strain vector.

In one implementation, a mesh training dataset of one or more mesh targets may be built. A jaw solver that optimizes a pose vector for a given mesh may be trained, and an expression solver may be trained based on a loss computed based at least in part on a ground-truth mesh and the actor mesh.

In one implementation, the trained neural network based shape transfer model may perform, using the jaw solver, eyes and jaws alignment by solving mandible movement.

In one implementation, the trained expression solver may reconstruct the skin expression corresponding to the actor, and transform the skin expression corresponding to the actor to the animated character facial expression pose.

In one implementation, an editing tool interface may be provided, at which a user manually edits the animated character facial expression pose. The editing tool interface include a brush element that allows a user to contract or elongate a muscle curve via a movement of the brush element.

### BRIEF DESCRIPTION OF THE DRAWINGS

Various embodiments in accordance with the present disclosure will be described with reference to the drawings, in which:

FIG. 1 illustrates an animation pipeline that might be used to render animated content showing animation of a character based on a model and a rig that is generated from scans of a live actor, according to embodiments described herein.

FIG. 2 illustrates an example neural network that might take in scan results and an anatomical model and output a muscle model to muscle model storage and a manifold-to-manifold storage, according to embodiments described herein.

FIG. 3 illustrates an example of a data structure that might represent a muscle model, according to embodiments described herein.

FIG. 4 illustrates inputs and outputs of an animation creation system, according to embodiments described herein.

FIGS. 5A and 5B are an example block diagram illsutrating an example facial animation pipeline built on a face parameterization using contractile muscle curves, according to emboidments descirbed herein.

FIG. 6 is a block diagram illustrating an example architecture of the face animation pipeline, according to embbodiments described herein.

FIG. 7A is a block diagram illustrating an example neural network based structure to implement the facial modeling module, according to embodiments described herein.

FIG. 7B provides a flow diagram illustrating an example training process of the structure in FIG. 7A, according to embodiments described herein.

FIG. 7C provides a flow diagram illustrating an example process of the facial animation module, according to embodiments described herein.

FIG. 8 is an example diagram illutrating a data example depicting an actor mesh, a volumetric representation, a representation of muscle fibers with eye and jaw alignment, and all-inclusive model, according to embodiments described herein.

FIG. 9 is a diagram illustrating a digital representation of an actor's performance, using the face animation pipeline described in FIG. 6, according to embodiments described herein.

FIG. 10 illustrates a digital representation of an actor, a representation of the character generated from processing the character without guide shapes, and a representation of the character generated from processing the character with a fixed mouth via guide shapes, according to embodiments described herein.

FIG. 11 illustrates an example visual content generation system as might be used to generate imagery in the form of still images and/or video sequences of images, according to embodiments described herein.

FIG. 12 is a block diagram that illustrates a computer system upon which the computer systems of the systems described herein and/or visual content generation system may be implemented, according to embodiments described herein.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

In view of the need for accurate and efficient facial animation systems, embodiments described herein provide a three-dimensional (3D) facial processing system that can be used for animator-centric and anatomically-driven 3D facial modeling, animation and transfer. Specifically, a collection of muscle fiber curves may be considered as an anatomic basis, whose contraction and relaxation are defined as a fine-grained parameterization of human facial expression. An end-to-end modular deformation architecture may then be built using this representation to implemtn automatic optimization of the parameters of a specific face from high-quality dynamic facial scans; face animation driven by performance capture, keyframes, or dynamic simulation; interactive and direct manipulation of facial expression; and animation transfer from an actor to a character.

For example, muscle-based parameterization may be constructed by inverse simulating a representative set of skeletal face muscles embedded within a tetrahederalized flesh mask. An artist-curated, minimal yet meaningful set of muscle fiber curves are then selected to capture muscle contraction along pennation directions. Specifically, these muscle fiber curves may not need to be an accurate representation of an actual muscle fiber of any actor but rather the curves are informed and representative of human musculature. In one example, these muscle fiber curves may be extracted from cadaveric data, or traced over in-vivo 3D muscle imaging, or even extracted from artist modeled 3D muscles. While most curves are aligned along actual annotomical muscle fibers, some may run orthogonal to muscle fibers to capture information cross-sectional to the muscle.

In one embodiment, sheet muscles have fiber bundles that can contract selectively, and these are captured using multiple parallel fiber curves. In this way, compared to contraction, the bend and twist of muscle fiber curves were minimal. Next, both the bending of muscle and the volumetric squash and stretch orthogonal to the contracting muscle are captured, by introducing curves orthogonal to the muscle fibers, and attached to soft tissue in the flesh mask. While this deviates from a strict anatomic mapping of curves to muscle fibers, it facilitates an animator-friendly representation of a deformable face as a homogeneous collection of contractile 3D curves. A unitless strain value may be computed to capture the change in length of an activated muscle curve relative to its length in a neutral state.

In one implemetnation, the facial processing system described herein provides a user interface for artisitc control. While the performance capture of physical actors principally animates faces generated using a (3D) facial processing system as described herein, it might be desirable to have the ability of animators to edit the results and to hand-craft animation in scenarios where physical capture is difficult. In one implementation, the system is designed as a set of deformation nodes integrated into production pipelines in a commercial animation system like Maya, wherien face representations allow forward (inside-out), and inverse (outside-in) type animation control of facial expressions.

In one implemetnation, the facial processing system generates anatomically grounded representation for anthropomorphic faces strongly tied to a human face's musculature. Beyond a generic representation of 3D geometry, a parameterization that explicitly embodies the anatomy of the human face is built. While many surface and volume muscle representations exist, the simulated behavior of the muscle is captured for efficient kinematic control.

In one implementation, the facial processing system is built as an end-to-end automated system based on a face representation that generates high-resolution faces from artist-curated 3D scans. All system components aim to optimize the face to conform to an actor's input data.

In one implemetnation, the facial processing system generates transferable animation, e.g., from an actor face to a character face. The visual effects pipeline for motion-captured character animation relies on a two-step process. A digital double of the actor is first made and animated to match the captured performance with high fidelity before transferring the animation to the character, with minimal user oversight.

The facial processing system described herein improves upon existing animation techniques, such as FACS AU-based blendshapes or facial rigging. Traditional blendshapes are an artist-sculpted set of target faces, often aligned with FACS AUs, used extensively in film and games over decades. Facial expressions are produced as a linear combination of blendshapes. While blendshapes give artists some control over the face, modeling and animating a realistic face require a significant artistic skill. Adding corrective shapes is common and high-end blendshape rigs are unwieldy with many redundant, correlated, and mutually exclusive shapes. Instead, a compact facial representation of muscle curves adopted by the facial processing system might be used. In one specific example, there are 178 muscle strains, jaw and eye positions, which can be represented in memory as a 178-parameter facial representation that is rather compact.

In addition, the interactive manipulation of the high-dimensional space of blendshape weights is also difficult, motivating research in control layouts and inverse weight computation to fit direct manipulation of the face or sketched facial feature. Further, blendshapes neither guarantee the plausibility of facial expressions nor span all plausible expressions. The facial processing system as described herein can admit interaction with muscle curves, brush-based direct manipulation, and a parametric manifold of plausible expressions using a muscle simulation to fit a comprehensive corpus of dynamic face scans.

In addition, traditional facial rigging generally includes various controls, including skeletal joints (e.g., to control a jaw and eyeballs), and other deformers, to manipulate facial expressions. Several deep-learning-based rig approximations were proposed to replace the complexity of facial rigs but with significant computational complexity. In contrast, the muscle curves adopted by the facial processing system described herein complement skeletal deformation and operate as part of an animation chain.

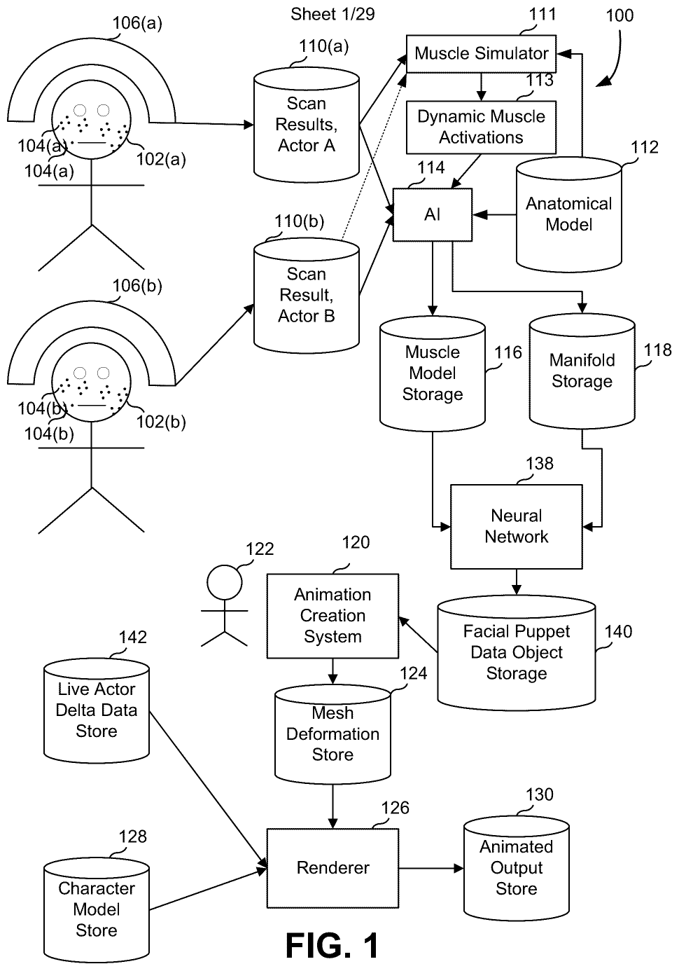

FIG. 1 illustrates an animation pipeline 100 that might be used to render animated content showing animation of a character based on a model and a rig that is generated from scans of a live actor. As illustrated there, a live actor 102 (“Actor A”) might be outfitted with fiducials 104 and have their face, expressions and/or body scanned by a scanner 106. The scanner 106 would then output or store results of scanning to a scan results store 110. The fiducials 104 allow for the scan data that results from scanning to include indications of how specific points on the surface of the face of the live actor 102 move given particular expressions. Salient features of the live actor themselves might also serve as fiducials, such as moles, portions of the eyes, etc.

Scans can be done across multiple live actors, generating separate data for each, as in Actor A (live actor 102(a)) having fiducials 104(a), a scanner 106(a) and scan results 110(a), while Actor B (live actor 102(b)) having fiducials 104(b), a scanner 106(b) provides for scan results 110(b). In some embodiments, a single scanner can be used to separately capture expressions and facial movements of many different live actors.

If the scanner 106 captures data in three dimensions (“3D”), the scan data could also indicate the surface manifold in 3D space that corresponds to the surface of the live actor's face. While it might be expected that the skull of the live actor 102 is a constant shape and changes only by translations and rotations (and jaw movement), it is not expected that the surface manifold would be constant, given jaw movements, air pressure in the mouth, muscle movements, and as other movable parts move and interact. Instead, different movements and facial expressions result in different thicknesses, wrinkles, etc. of the actor's face.

It might be assumed that each human actor has more or less the same facial muscles. An anatomical model dataset 112 might be provided that represents muscles, where they connect, what other typical facial elements are present (eyes, eyelids, nose, lips, philtrum, etc.) and other features likely common to most human faces. Of course, not all human faces are identical, and the actual positions of muscles, their thicknesses, where they connect to, how much they can relax and contract, are details that can vary from person to person, as well as the shape of their skull. It is typically not practical to directly determine these details from a specific live actor, as that might require invasive procedures or complex computerized axial tomography (CAT) or Magnetic resonance imaging (MRI) scans.

In some implementations, the scan results, e.g., of actor A and/or (optional) of actor B, may be provided to a muscle simulator 111 for analyzing the muscle movement from the scans, which may in turn generate dynamic muscle activation data 113 that is provided to the Artificial Intelligence system 114. In some implementations, scan results relating to another actor B 110(b) can also be sent to the muscle simulator 111 for generating dynamic muscle activations 113 based on scan results of actor B.

In one embodiment, the muscle simulator 111 may obtain an anatomical model from anatomical model dataset 112 as well, based on which the muscle simulator 111 may generate dynamic muscle activations for actor A or B. In some implementations, the muscle simulator 111 may obtain a generic anatomical model that is applicable to either actor A or actor B. In another implementation, the muscle simulator 111 may obtain a specific anatomical model customized for actor A or actor B, based on which dynamic muscle activation that is specific to actor A or B may be generated, together with the scan results 110a for actor A or the scan results 110b for actor B, respectively.

To determine the underlying specifics of a live actor, an Artificial Intelligence (AI) system 114 obtains the scan results from scan results store 110 and an anatomical model from anatomical model dataset 112, and infers—perhaps by iterative training—the shape of the live actor's skull, volume of muscles, range of motion, etc., to build a muscle model for the actor that is stored in muscle model storage 116, which might store different models for different actors. The AI system 114 might also output a manifold to be stored in manifold storage 118. Muscle model storage 116 might store muscle models over a plurality of live actors and manifold storage 118 might store manifolds over the plurality of live actors. The manifold might represent the range of plausible expressions, which can vary from actor to actor. Logically, the manifold might represent a set of solutions or constraints in a high-dimension space corresponding to a strain vector.

Using an animation creation system 120, an animator 122 could generate meshes that correspond to facial expressions of the live actor for whom the muscle model was derived. A mesh might be stored in a mesh deformation store 124. If mesh corresponded to the facial surface of the live actor, the animation creation system 120 could be used by the animator 122 to generate a facial surface of an expression that was not specifically made by the live actor, but would be near what it would be if the live actor had tried that expression. The animation creation system 120 might constrain an animator's inputs by projecting them onto the manifold, which would have an effect of transforming animator inputs that are not corresponding to a plausible expression into a strain vector that does correspond to a plausible expression. The animator's inputs might be represented in memory as a strain vector, having components corresponding to some facial muscles, as well as other animation variables that might not be related to muscles or that are more easily represented directly, such as jaw movement, eye movement, and the like.

A renderer 126 can process the facial surface, perhaps mapping it to a character model from a character model store 128, such as a non-human character played by the live actor, to form animated output that might be stored in animated output store 130.

To handle multiple live actors, the muscle models and manifolds of a plurality of live actors might be provided to a neural network 138 that can derive from them a facial puppet data object that corresponds to feasible and/or possible facial movements that might be applied to various characters based on various live actor performances. The facial puppet data object might be stored in facial puppet data object storage 140, which in turn can be supplied to animation creation system 120. The renderer 126 might also use live actor delta data from a live actor delta data store 142 to inform rendering.

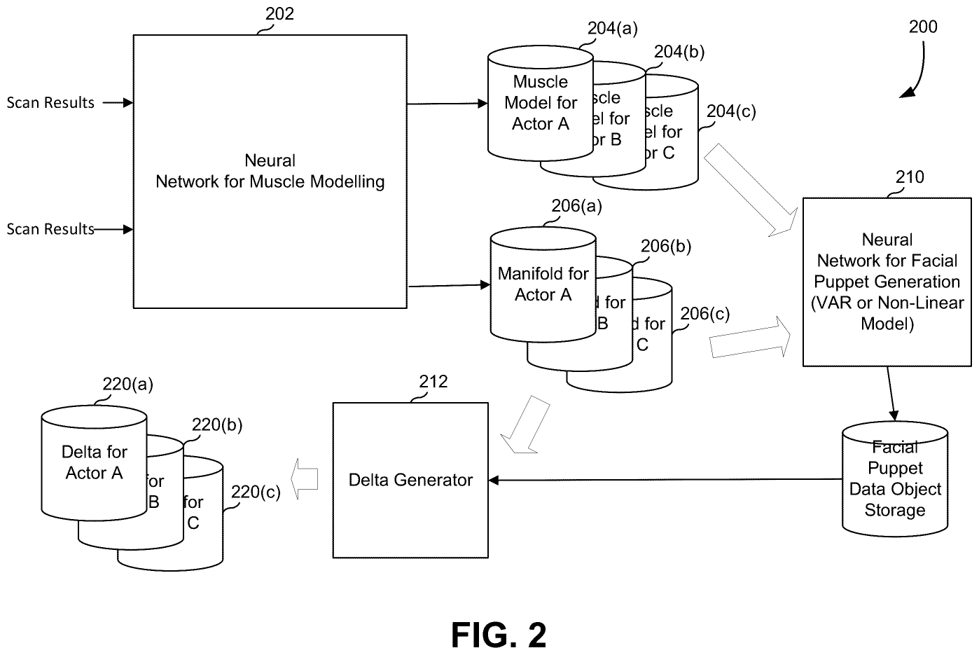

FIG. 2 illustrates an example neural network 202 that might take in scan results and an anatomical model and output a muscle model to muscle model storage 204 and a manifold-to-manifold storage 206. The scan results from different live actors might be stored separately, as muscle models 204(a)-(c) and manifolds 206(a)-(c). A neural network 210 for facial puppet generation might use those to derive a facial puppet. A delta generator 212 might generate “deltas” for some or all of the live actors represented in the muscle models and manifolds. The deltas 220 would allow for an animation artist to work with the facial puppet independent of the particular live actor or the character played by the live actor and then the variances specific to that live actor can be merged in afterwards.

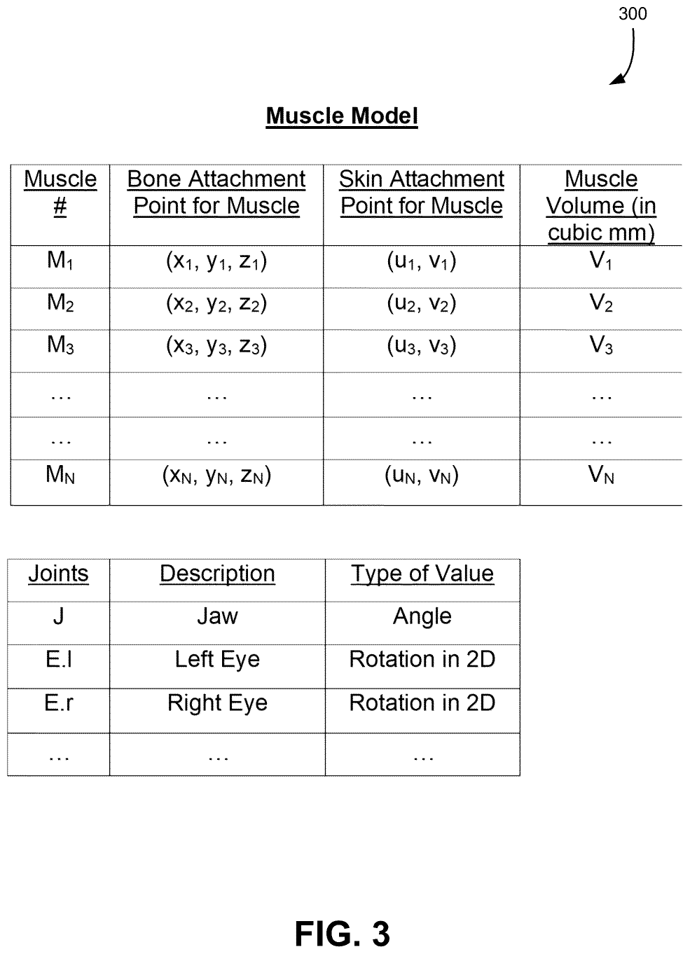

FIG. 3 illustrates an example of a data structure that might represent a muscle model. In that model, each muscle might be defined by a bone attachment point, a skin attachment point, and a muscle volume. In animation, as the strain on a muscle changes, the volume of the muscle might change shape, and the distance between the bone attachment point and the skin attachment point might change, thus creating expressions. Additional elements might be included in a control vector that are for other animation variables.

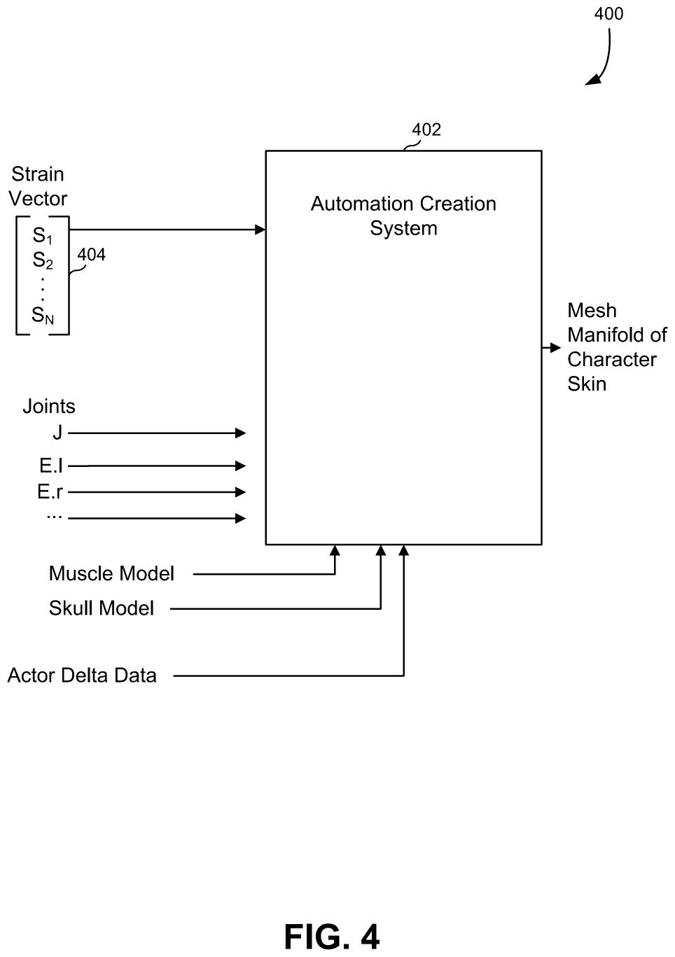

FIG. 4 illustrates inputs and outputs of an animation creation system 402. Inputs might include an input strain vector 404, indicative a strain values for some or all of the muscles in the muscle model, and values for the other animation variables, such as a scalar value for a jaw angle, two 2D vectors corresponding to rotations of the eyes, etc. Along with the muscle model, which describes where the muscles are attached and their volume, and a skull model representing an actor's skull shape and contour, and a control vector for other non-muscle animation variables, the animation creation system 402 can determine the volumes occupied by the muscles, and thus the surface of the character's skin, and output a mesh manifold of the character's skin, possibly depicting an expression corresponding to the input strain vector 404. Where facial puppets are used, the muscle model and skull model might instead be represented by the facial puppet and the automation creation system can use the delta data for the particular live actor.

Using the above methods and apparatus, an animator can specify a facial expression in the domain of muscle semantics, which can simplify an animation process compared to limiting the animator to making combinations of recorded expressions as blends of the scanned facial shapes. In the general case, a length of a muscle is determined from its strain value and its rest length. Allowed strain values might be constrained by the manifold so that strain values remain within plausible boundaries. For a given scan of an expression on a live actor's face, a muscle model for that live actor, and a skull model for that live actor, an AI process can determine a likely strain vector that, when input to an animation generation system, would result in an expression largely matching the scanned expression. Knowing the strain values, the animation generation system can provide those as the domain in which the animator would modify expressions. After training an AI system using dynamic scans of a live actor's face as the ground truth for training, the muscle model can be derived that would allow for the simulation of other expressions that were not captured.

In some instances, there might be more than one hundred muscles represented in the muscle model and the AI system that extracts a strain vector and a control vector from dynamic scans of a live actor might be able to provide approximate solutions to match expressions. The control vector might include other values besides jaw and eye positions.

As explained herein, an animation process might simulate facial expressions through the use of a unique combination of hi-resolution scans of a human face, simulated muscles, facial control vectors, and constraints to generate unlimited facial expressions. In one embodiment, an AI system is employed to receive facial control vectors generated from a series of muscle strain inputs and process those vectors relative to a facial expression manifold configured to constrain facial expressions of the simulation to plausible expressions.

Separate AI systems might be used to train and derive the muscle model and to train and derive the manifold. In some embodiments, in order to hit a target expression (and corresponding skin shape), the muscle model might be differentiable. An AI system might include a variational auto-encoder (VAE).

The AI uses muscle control vectors, instead of blendshape weights or other approaches, and can then specify strains on those muscle control vectors, which would in turn specify lengths of contractions of the muscles in a simulator. Each muscle scan be represented by a curve, which might have a length that is a function of the strain. A muscle vector might comprise strains that affect a mesh representing the skin of a character. The muscles might include a rest length and attachment point, and together represent a muscle geometry. Using the combination of the input scans, the strains, the muscle control vectors, and manifold constraints, an animation system can output plausible facial expressions.

Once a facial puppet is generated, it can be provided to an animation system so that an animator can specify facial expressions and movements for computer-generated animation imagery.

The facial puppet is derived from scans of multiple live actors and the facial puppet models the anatomically informed properties of actors' faces and applies statistically-derived properties through to the character.

Global manifolds or actor-specific manifolds might be provided, wherein a manifold constrains what strain vectors can be applied to the facial puppet, allowing the animator to animate the facial puppet while guiding a facial animator to stay inside of a character look while minimizing the need for manual intervention to modify the actor/character manifold.

A brush tool might be included to automate the puppet build and allow facial animators to pose a face guided by a learned manifold. An Actor-to-character transfer tool might provide for transferring an actor's facial shape motion to a character. The tools might be part of an animation system that handles other tasks. The animation system might include the Maya tools provided by Autodesk, Inc. of San Rafael, CA.

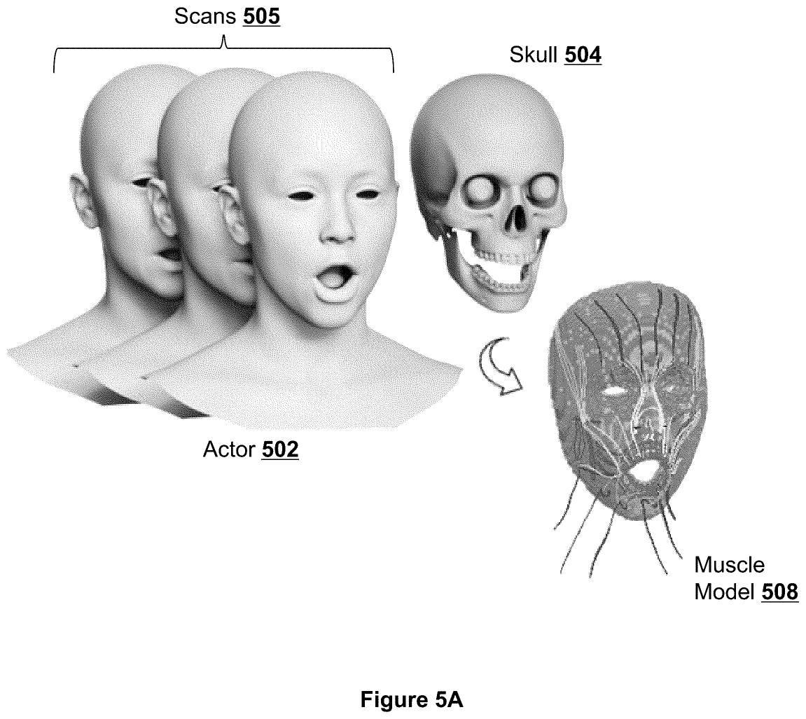

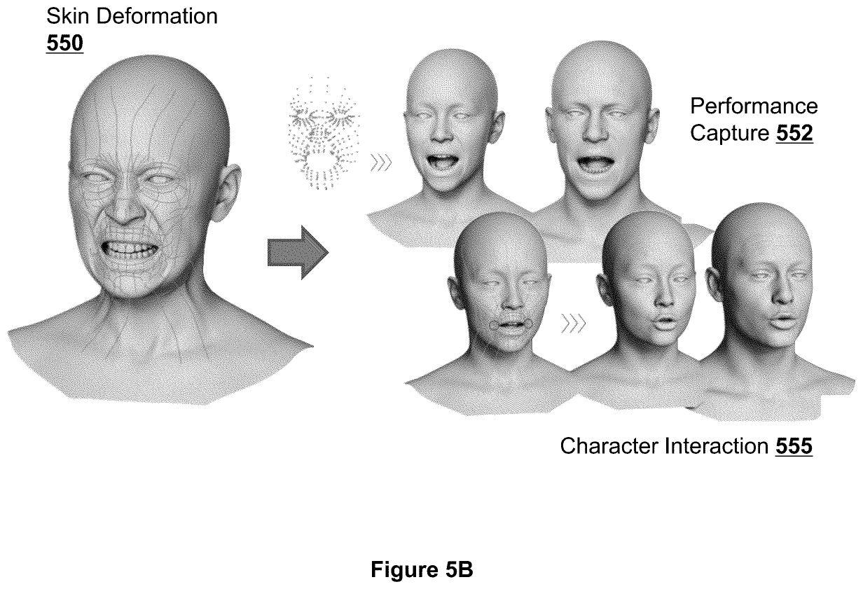

FIGS. 5A and 5B are an example block diagram illsutrating an example facial animation pipeline built on a face parameterization using contractile muscle curves, according to emboidments descirbed herein. As shown in FIG. 5A, a set of dynamic 3D scans 505 for an actor 502 (e.g., similar to 102a-b in FIG. 1), and optional parameters of the skull information 504 of the actor, may be used for the construction and fitting of the muscle curves using a passive muscle simulation model 508.

Muscle contractions (strains) parameterize these scans 505 and are obtained to learn a manifold of plausible facial expressions. For exampel, the face expressions described herein can be parameterized by a vector of strains corresponding to the 178 muscle fiber curves that are used to define a human face as shown in the muscle model 108. In other implementations, fewer or more than 178 muscle fibers are used.

As shown in FIG. 5B, the strains, in turn, control skin deformation 510 and readily transfer expression from an actor to characters. In production, the strains can be animated to produce various facial expressions in a character face, e.g., performance capture 512 and animator interaction between charfacters 515.

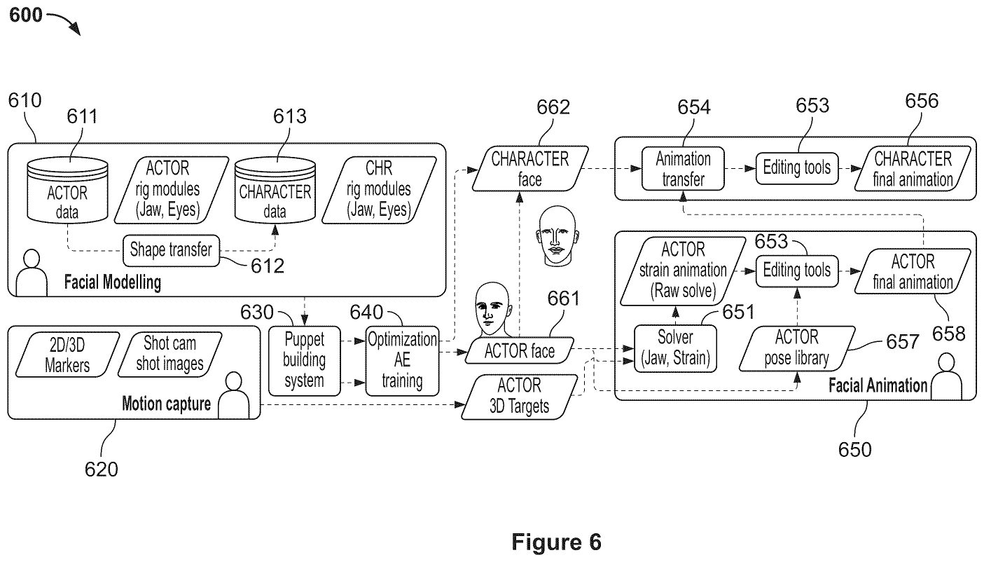

FIG. 6 is a block diagram illustrating an example architecture of the face animation pipeline 600, according to embbodiments described herein. The face animation pipeline 600 comprises a facial modeling module 610, a motion capture module 620, a puppet building system 630, an autoencoder (AE) training optimization module 640, a facial animation module 650, and/or the like.

In one embodiment, the (3D) facial processing system shown at diagram 600 in FIG. 6 and as described herein might have a deformation architecture similar to that of the “FLAME” system described in [Li] and use a similar vertex-based skinning approach with corrective shapes, e.g., with N=85,000 vertices and K=3 joints (jaw and eyeballs). The FLAME system relies on PCA weights to drive facial animation, reducing shape and expression spaces to their principal components. The system described herein (e.g., as shown in diagram 600 of FIG. 6), in contrast, is based on muscle strains, which provide an anatomically meaningful and animator-friendly basis to represent and control facial expressions.

In one emboidment, the motion capture module 620 may be used to obtain shot images of a live actor who has been applied with 2D or 3D markers (such as, but not limited to the fiducials 104a-b in FIG. 1). For example, the actor is asked to perform FACS actions, a comprehensive range of emotions, and utter various phonemes and Harvard sentences, that result in a reconstructed 3D facial dataset (by the facial modeling module 610): comprising 80 motion clips (≈7,000 frames) in which facial actions (FACS+emotions) and speech are present in equal proportion. For example, the scanning follows the LightStage setup, and then includes post-processing the raw scans. In this way, the motion capture module 620 generate raw actor dynamic scans for the facial modeling module 610.

In one embodient, the facial modeling module 610 may reconstruct 3D shapes of an actor's face using photogrammetry (3DF Zephyr 3DF_Zephyr) to model the rest state of skin, eyes, teeth, and maximal ranges for unassisted jaw opening, protrusion, and lateral movement. A skull is fit inside the scanned model by approximating tissue depth data with medical/forensic pegs placed on the skin and skull, and varying peg-length based on actor age, gender, ethnicity, and Body Mass Index (BMI). In this way, a temporally-aligned mesh sequence using sequential registration (R3DS Wrap wrap3) may be obtained, and head movement removed by rigid stabilization.

For example, to parameterize the fiber-based muscle model, a tetrahedral volume can be defined discretizing the soft tissue of the face in the rest-pose. A passive, quasi-static simulation is then performed to this volume for whole scan sequences with skin vertices and the skull enforced as positional constraints for tetrahedral elements. For instance, 135K tetrahedrons are simulated constrained with multiple positional, sliding, and collision constraints. A barycentric embedding may be computed for control points for the anatomic muscle curves, within the rest pose tetrahedral volume. For each simulated frame, their barycentric coordinates are used to extract simulated muscle curves.

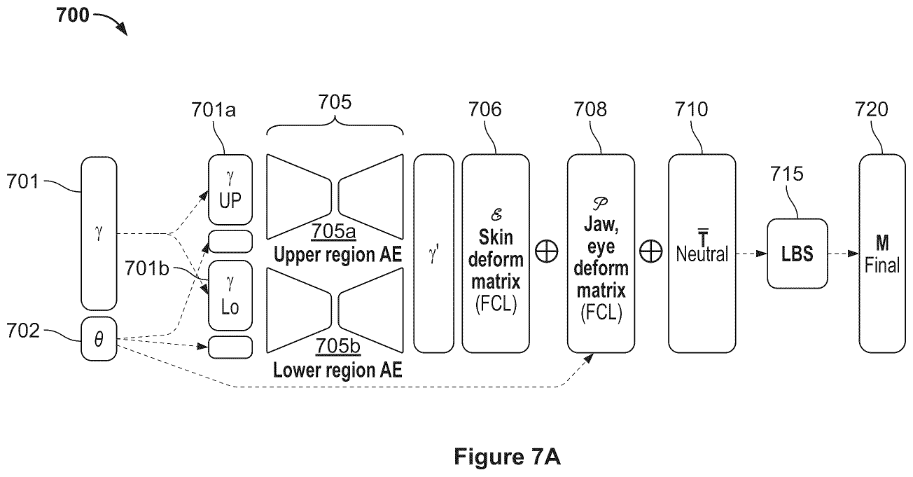

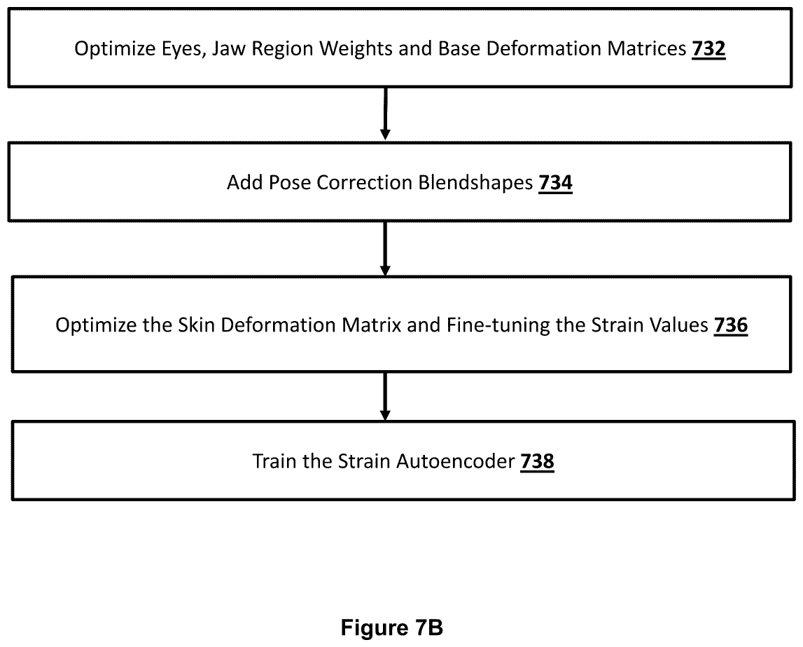

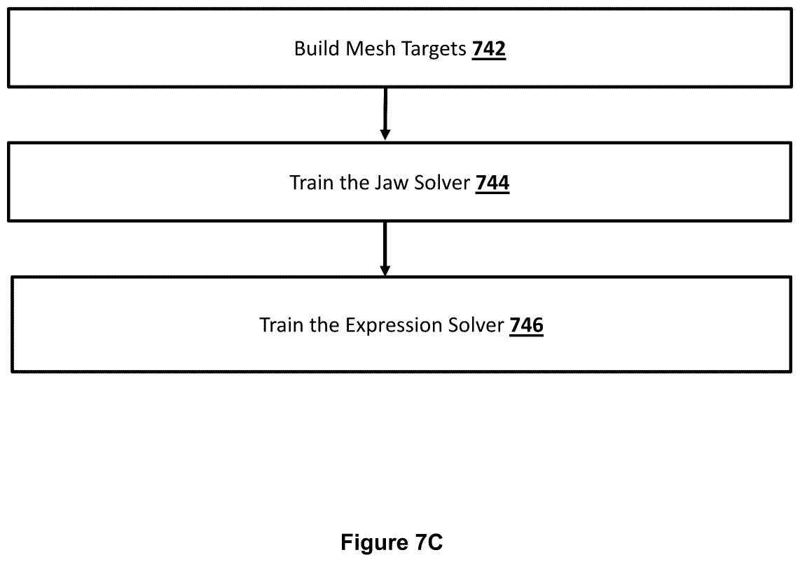

In one embodiment, the facial modeling module 610 may comprise a shape transfer module 612 that transfers the actor data 611 (e.g., jaw, eyes rig) to the character data 613 (e.g., jaw, eyes rig). Specifically, the pipeline 600 may foresee a different model and rig for the actor and the character. To maximize the parity between an actor and a character face in the animation transfer stage, character training process may be designed to share the corresponding actor's underlying muscle behavior. To achieve this, shape transfer 612 may be performed before the character training stage to perfectly align transferred skin meshes with the actor's dataset in the correct order. Then, instead of considering an independent set of the character's muscle curves in the training stage, the actor's strain values and strain autoencoder can be used to optimize the strain-to-skin blendshapes (see 706 in FIG. 7). Consequently, the final character facial model will have the shared strain autoencoder identical to the actor (see FIG. 4).

In one embodiment, the shape transfer module 612 may utilize cage-based transfer to transfer the character's skin data 613 from the actor's skin data 611. A correspondence matrix may be computed using RBF between the actor and the character neutral shape at cage resolution. When the proportion of specific regions of the actor's and character's face is similar, multiple such correspondence matrices may be further computed. Handling the eye and jaw regions separately for example, using user-defined weight maps, can allow more accurate expression transfer for those parts.

In one emboidment, the shape trnasfer module 612 may also fit the actor's jaw rig to the character and use it to compensate for the deviation in teeth topography and skull anatomy. LBS weights may be computed for the jaw joints from an example scan of the actor and use the same UV-based weights for the character. Given matching jaw set-ups, the jaw rotation mahy be unposed to handle the substantial movement around the mandible region that is not appropriately captured by the cage displacements. This unposing stage is also helpful in aligning the rigid inner mouth regions.

A puppet building system 630 may create a facial rig for the character face based on the character data after shape trasnfer 612. Muscle strains simulated on dynamic scans produce a highly accurate reconstruction of a scanned actor, superior to FACS-blendshape systems with comparable data; Muscle curves may be a good spatial proxy for selection, visualization, deformation, and reinforce artist knowledge of facial anatomy; Modular workflow aids in model troubleshooting and allows selective improvement.
For example, a scan protocol of ≈80 clips can be time-consuming for celebrity actors and computationally expensive to process; dynamic scans are temporally unique to actors and hard to re-purpose.

In one embodiment, the facial modeling module 610 may be implemented by a neural network based structure as further described below in relation to FIG. 7. The AE training module 640 may perform training of the neural network based structure for facail modeling. Therefore, the trained facial models may generate the reconstructed actor face 661 and the character face 662 for facial animation 650.

In one emboidment, the facial animation module 650 may receive actor face data 661, based on which to animate the actor's digital double that matches the facial expressions with very high fidelity and then transfer the animation to the character model. The optimal pose and strain inputs for each given frame may be obtained. Given the 3D-tracked motion capture facial markers, target meshes may first be built, which explains the given markers the best. Mapping facial meshes to marker space is a projection; hence its inverse is under-constrained and ill-defined, but the training dataset can be leveraged to find the best pseudo-inverse, as described in further detail in FIG. 7B.

For example, the facial model (as described in FIG. 7A) is end-to-end differentiable by design; hence this inverse problem of solving with gradient descent as a two-step process. The first step computes the pose inputs \vec{θ} (eyes rotations and jaw controls), and then the jaw proxy model plays a central role in computing the gradients. The solver at this stage captures all skin deformations correlated to the joints' rigid transformations. This may be achieved by keeping the strains constant equal to the neutral vector γ₀. The resulting poses can then be projected into camera space and compared to the shot images. Here artists can visually validate the results, and manually re-align the teeth, if further accuracy is required. The second step fits the strains to capture all residual skin deformation. Implausible expressions are avoided by adding a regularization term to keep strain values within the space that the AE was trained to preserve. In the absence of artist validation, multiple alternating iterations of the two steps can yield better results. The facial solver assumes coherent sequences instead of individual frames to enforce temporal coherence. When solving long shots (≥1K frames), memory issues may be avoided by partitioning the sequence into tractable sub-sequences, blended afterward.

The facial animation module 650 may comprise a jaw-strain solver 651, which perform eyes and jaws alignment by solving mandible movement using a complex non-linear jaw rig. A least-squares optimization may be performed to fit the jaw rig to the mesh sequence.

Specifically, a facial rig to animate accurate jaw animation relies on a complex non-linear function, which maps the 3D jaw controls to the applied 6D rigid transformation. It is embedded deep inside the jaw rig and may not be easily be formulated analytically. Consequently, the mapping may be approximated with an easily trainable and infinitely differentiable Radial Basis Function (RBF) network χ.

The rigid jaw transformation to map to is a 6D vector (translation and axis-angle rotation). The Gaussian kernel can be obtained as the RBF. Let μ and σ be its parameters and [symbol] ³ be its input space:

∀p, μ, σ∈ [symbol] ^{3×3×1}, g_{μ,σ}(p)=exp(−σ²∥p−μ∥²).

Given the parameters {ψᵢ, μᵢ, σᵢ|i≤N}∈ [symbol] ⁶× [symbol] ³× [symbol] and the number of neurons M=50, the RBF network χ:

$$∀ p ∈ {ℝ}^{3} , χ ( p ) = \frac{{\sum }_{i = 1}^{M} {ψ}_{i} \cdot {g}_{i} ( p )}{{\sum }_{i = 1}^{M} {g}_{i} ( p )} , with {g}_{i} = {g}_{{μ}_{i} , {σ}_{i}} .$$

The resulting animation may be presented to an artist via an editing tool interface 653, at which the actor may manurally edit the actor animation 653 (e.g., by lifting the position of lips, by enlarging or reducing the distance between eye brows and eyes, and/or the like). For example, it is a significant paradigm shift for animators, experienced in using FACS-blendshapes to animate the face. To facilitate adoption, the editing tool 653 may provide a set of brush-based, animator-centric tools. The tools operate either on the strains (muscle manipulation; inside-out) or the mesh (e.g., direct manipulation, outside-in). They interact locally with the facial model, using a radial, brush-influence area around the mouse cursor. The length of the stroke can modulate the strength of the brush, and a symmetric mode optionally mirrors the effect of the stroke, either bilaterally, or radially around the mouth and eyes.

In one implementation, a tool-set for a (3D) facial processing system may allow users can have complete control over individual muscle strains. Here muscle curves displayed beneath the skin surface, can be contracted/elongated using brush strokes, to interactively deform the mesh.

In another implementation, a strain-based pose library 657 may be used. Analogous to FACS-blendshape control, the pose brush tool provides high level expression control. A pose is defined by a set of associated strain values. Animators can curate a pose library with typical expressions for each facial rig. Selected strains of these poses can be dialed in/out towards their absolute values, or relative to the current facial expression.

In another implementation, at an abstract level, the direct manipulation tool allows artists to sculpt mesh vertices directly to desired expressions. The brush strokes here, directly deform mesh vertices to provide a target skin mesh. Strain values as well as jaw+eye controls that best-fit the target mesh may be computed as the user engages with a brush stroke. The GPU-based implementation provides near real-time performance (≈15 fps), suitable for interaction, but costlier than the forward deformations using strain-based brushes.

The resulting animation 658 may be verified by observing teeth alignment against images captured from each camera. Soft tissue depth between the skin surface and mandible may be compared to verify frames where the surrounding soft tissue occludes the teeth. The resulting 3D transformations represent the mandibular movement for the performed action or speech. The transformations are also used to reconstruct the inner mouth occluded or shadowed in the original photogrammetry. The eye model approximates the actor's sclera, cornea, and iris. Eye gaze direction is adjusted in each frame of the mesh sequence by rotating the eyeballs so that the iris model aligns with the limbal ring and pupil, visible on the images captured from each camera. Multiple camera angles are used to verify the alignment and account for light refracted by the cornea. Well-aligned rotations for the eyes allow us to correct for minor deformation artifacts in the surrounding geometry. A small frontal translation (eye bulge) is tied to eye rotation to enhance eye realism.

Referring back to FIG. 6, in another implementation, the actor animation 658 may be transferred, via animation transfer module 654, based on charafcter face 662, to generate character animation. Similarly, an artist may use an editing tool 653 to edit the charcter animation that results in the final character animation 656.

Specifically, as an actor and a corresponding character pair share their strain space from the training stage, transferring animation from one to the other is trivial. The strain and control parameters may be directly connected between the actor and the character for real-time animation transfer. Note that no expression cloning or re-targeting, commonly used in FACS-based systems is necessary.

FIG. 7A is a block diagram illustrating an example neural network based structure 700 to implement the facial modeling module 610, according to embodiments described herein. The facial model structure 700 receives an input of a strain vector 701 and a vector describing pose 702, and encode the input via an autoencoder 705. The encoded representation is then passed through a fully connected layer for skin deformation matrix 706, a fully connected layer for jaw and eye deformation matrix 708, a neutral mesh 710, a linear blend skinning 715 to produce a final output of muscale model M 720.

Specifically, a function M(\vec{θ}, \vec{γ}): [symbol] ^{|\vec{θ}|×|\vec{γ}|}→ [symbol] ^{3N} maps a vector describing pose 702 (jaw and eyes transformations) \vec{θ}∈ [symbol] ^{|\vec{θ}|} and expression (encoded by muscle strains \vec{γ}∈ [symbol] ^{|\vec{γ}|} 701), to N vertices. As shown in FIG. 7, the model can comprise a neutral mesh 710 T̅∈ [symbol] ^{3N} (unposed and expressionless); the corresponding rest-pose vector \vec{θ}*; corrective pose blendshapes B_{P}(\vec{θ}; [symbol] ): [symbol] ^{|\vec{θ}|}→ [symbol] ^{3N} to correct pose deformations that cannot be produced by linear blend skinning (LBS 715); strain-driven blendshapes B_{E}(\vec{γ};ε): [symbol] ^{|\vec{θ}|}→ [symbol] ^{3N} capturing facial expressions; and a strain-jaw autoencoder 705 AE_{Φ}(\vec{γ}, \vec{θ}): [symbol] ^{|\vec{γ}|+|\vec{θ}|}→ [symbol] ^{|\vec{γ}|} (parameterized by its weights Φ), to enforce non-linear muscle strain behavior. The final M 720 is formulated as:

M(\vec{θ}, \vec{γ})=W(T_{P}(\vec{θ}, \vec{γ}), J, \vec{θ}, [symbol] ), T_{P}(\vec{θ}, \vec{γ})=T̅+B_{P}(\vec{θ}; [symbol] )+B_{E}(AEΦ(\vec{γ}, \vec{θ}_{jaw}); ε).

where T_{P} denotes the addition of pose and expression displacements to the neutral mesh and W (T_{P}, J, \vec{θ}, [symbol] ) is a skinning function to transform the vertices of T_{P} around joints J∈ [symbol] ^{3K+3}, linearly smoothed by skinning weights [symbol] ∈ [symbol] ^{N×K}. The various components used to produce the final M 720 are described below.

### Muscle Features (Strains) \vec{γ} 701

From each muscle curve of length s, a unitless real-valued strain γ=(s−s̅)/s̅, where s̅ is the length of the muscle curve at the neutral frame (rest-pose). Strain is thus a deviation from a muscle curve's rest-pose length. A negative/positive strain is thus a muscle contraction/relaxation relative to its rest-pose tension. The strain values for all the |\vec{γ}| muscles at frame t are grouped together in a vector \vec{γ}^{(t)}, and Γ={\vec{γ}^{(t)}|t≤T} for a given sequence of T frames.

### Strain Autoencoder 705

Though the underlying concept of muscle elongation or contraction might be intuitive, driving a facial expression with the strain vector is not always straightforward. The autoencoder (AE) 705 is used to assist artists by constraining the strain vector to remain within the boundaries of plausible face animation, referred to as the expression manifold. Human interpretation defines plausibility here, and this manifold is thus estimated with a curated sampling of multiple facial expressions and their corresponding strain vectors.

The AE 705 might perform a projection onto this space without being restrictive. It should naturally support the animators in directing any desired facial expression as long as they remain within the manifold while preventing mistakes and incorrect manipulations from producing uncanny expressions. To achieve this behavior, a small-scale neural network of three encoding and three decoding layers may be trained, which first project the input vector into a latent space before reconstructing the strain values. The latent space is about two times smaller in dimension than the input space to apply a lossy compression and force the AE to exhibit the projecting behavior. The strain vector lacks a structure for leverage in the network; hence only dense (fully-connected) layers are relied upon and cELU and Tanh activation functions are added for non-linearity.

Because of the natural predisposition of specific unrelated facial muscles to be activated in unison, like the lip corner puller causing the eyes to squint, the AE tends to learn some—and replicates these—regional contaminations, which are undesirable for artistic control. In order to mitigate this issue and enforce some form of localized influence (changing a muscle should not affect remote parts of the face), the strain vector \vec{γ} 701 may be partitioned into two regions 701a and 701b: the muscles related to the upper (resp. lower) part of the face are grouped in the vector 701a \vec{γ}ᵤ (resp 701b. \vec{γ}ₗ). There is no overlap between the regions; hence |\vec{γ}|=|\vec{γ}ᵤ|+|\vec{γ}ₗ|. Similarly, the autoencoder 705 is comprised of two separate autoencoder networks 705a nad 705b with the structure described above, one for each partition of \vec{γ}. Note that the autoencoder may be referred to in a singular form as 705 due to the shared properties between the two 705a and 705b.

The AE 705 responsible for processing the lower vector \vec{γ}ₗ (resp. upper) is conditioned with the jaw pose (resp. eyes pose). The rigid jaw transformation is part of the input but not of the output and only serves to stabilize the AE with its ground-truth nature. The output of both AE networks is concatenated together to produce the final strain vector, which then drives the expression blendshape.

### Strain-to-Skin Deformation Matrix 706

Linear blendshapes model the strain-to-skin deformation matrix 706 to produce skin expressions as

B_{E}(\vec{γ}; ε)=Σᵢ₌₁^{|\vec{γ}|}Eᵢγᵢ=ε\vec{γ},

where ε=[E₁, . . . , E_{|\vec{γ}|}]∈ [symbol] ^{3N×|\vec{γ}|} denotes the optimized strain-to-skin deformation basis. These blendshapes are driven only by the strain vector and not by pose.

### Eyes and Jaw Base Deformation 708

Let R(\vec{θ}): [symbol] ^{|\vec{θ}|}→ [symbol] ^{9K+3} be a function from a pose vector 702 \vec{θ} (corresponding to jaw and eyeballs rig controls) to a vector containing the concatenated elements of all the corresponding rigid transformation matrices ( [symbol] ^{3×3} rotations for eyeballs, and [symbol] ^{3×4} rigid transformation for the jaw). Let also \vec{θ}* be the rest pose, corresponding to the neutral frame. The pose blendshape function is then defined as

B_{P}(\vec{θ}; [symbol] )=Σₖ₌₁^{9k+3}(Rₖ(\vec{θ})−Rₖ(\vec{θ}*))Pₖ,

where Rₖ(\vec{θ}) and Rₖ(\vec{θ}*) denote the k-th element of R(\vec{θ}) and R(\vec{θ}*), respectively. The vector Pₖ∈ [symbol] ^{3N} describes the corrective vertex displacements from the neutral pose activated by Rₖ, and the pose space [symbol] =[P₁, . . . , P_{9K+3}]∈ [symbol] ^{3N×(9K+3)} is a matrix with all corrective pose blendshapes.

In the neural network based structure 700, the unknown parameters of the model are the LBS weights [symbol] ={ωᵢₖ}∈ [symbol] ^{N×K} of LBS 715, the pose correction blendshapes [symbol] ={Pₖ|k≤K} in the jaw/eye deformation matrix 708, the strain-to-skin expression deformation matrix ε={Eₛ|s≤|\vec{γ}|} 706, and the AE weight parameters Φ of the AE 705. These parameters can be trained successively in this order on a dataset of around 7,000 corresponding ground truth meshes V̅, poses \vec{θ}, and strain vectors \vec{γ}.

For example, the LBS weights may first be updated to minimize ∥V̅−W(T̅, J, \vec{θ}, [symbol] )∥. This is not enough to account for all pose-related deformations, so the pose correction blendshape 708 may then be trained on the residual error by minimizing ∥W⁻¹(V̅)−T̅− [symbol] _{P}(\vec{θ}, [symbol] )∥ of the unposed mesh. Note, the LBS function W is invertible because the K weight maps partition the skin mesh vertices. Once all pose-related deformations are computed, the residual error is captured by the expression blendshape, which minimize ∥\hat{V}− [symbol] _{E}(\vec{γ}, ε)∥, where \hat{V} is the unposed mesh whose norm that is minimized in the previous step. At this stage, the skin deformation matrix & 706 can be optimized and the strain vector \vec{γ} is finetuned to have the lowest error.

The loss functions may also have regularization terms that reduce the influence of the parameters over specific outputs, primarily to reduce the amount cross-talk. The training losses are further detailed in FIG. 7B. When the three training steps are done, the resulting mesh V̅=W(T̅+ [symbol] _{P}(\vec{θ}, [symbol] )+ [symbol] _{E}(\vec{γ}, ε)) with high accuracy.

Next, the AE 705 may be trained to fit on the training strains. This learns a latent representation of the manifold implicitly defined by ground truth samples (all plausible expressions). Consequently, the strains may be preserved within this implicit space and correct those that do not conform to the manifold. Thus, the equality AE_{Φ}(γ)≈γ holds true for plausible expressions only. In addition, the neutral shape is critical for the animators, and its corresponding strain vector γ₀ has to be perfectly preserved by the AE 705. Hence, a system might enforce the equality AE_{Φ}(γ₀)=γ₀.

FIG. 7B provides a flow diagram illustrating an example training process of the structure 700 in FIG. 7A, according to embodiments described herein. At step 732, the training process may optimize eyes, jaw region weights and base deformation matrices 708. The first optimization targets the unknown skinning weights [symbol] . Given a ground truth animated mesh V^{(t)}∈ [symbol] ^{3N} and pose \vec{θ}^{(t)} (as functions of time), the rest-pose mesh T̅, joint locations J and the blend skinning function W, the following cost function is computed:

[symbol]

( [symbol] )=Σₜ₌₁^{T}∥V^{(t)}−W(T̅,J,\vec{θ}^{(t)}, [symbol] )∥²+λT∥ [symbol] ⁽ⁱ⁾− [symbol] ∥_{F}²

constrained by 0≤ωᵢₖ≤1, where [symbol] ⁽ⁱ⁾ are initial weight values provided by animators to bootstrap the iterative optimization algorithm. This initial estimation dramatically increases the convergence rate. The second loss term prevents some vertices from being activated by a joint they are far away from a phenomenon which tends to happen otherwise.

Because this is a constrained least-squares problem, the corresponding solver using CERES solvers can be used, which converges in about 50 iterations (with λ=0.1).

At step 734, the training process may add pose correction blendshapes. After convergence, the LBS function is able to explain most of the variance of the pose animation (jaw and eyes related movements) but not all of it. In order to further reduce the error, 9K+3 additional pose correction shapes are computed, which optimize according to the following minimization objective:

[symbol]

( [symbol] )=Σₜ₌₁^{T}∥\hat{V}^{(t)}−Σₖ₌₁^{9K+3}(Rₖ(\vec{θ}^{(t)})−Rₖ(\vec{θ}*))Pₖ∥²,

where [symbol] =[P₁, . . . , P_{9K+3}]∈ [symbol] ^{3N×(9K+3)} is unknown.

For this stage, the target mesh \hat{V}^{(t)} is computed by unposing the previous target V^{(t)}, i.e., by inverting the skinning function W. This inversion operation is feasible because there is no overlap in the weight maps of the different joints.

At this point, the structure 700 is able to match the pose animation with high accuracy as follows:

M(\vec{θ}, \vec{γ})=W(T̅+B_{P}(\vec{θ}, [symbol] ),J,\vec{θ}, [symbol] ).

This model can animate most movements related to jaw and eyes rigid transformations, but it is not able to match some soft skin deformations, like the shape of the lips. In order to finalize it, another blendshape [symbol] _{E} is added to match the expression component. This blendshape system is driven by the strain values \vec{γ}∈ [symbol] ^{|\vec{γ}|}.

At step 736, the traning process may optimize the skin deformation matrix 706 and fine-tune the strain values 701. Let \tilde{V}^{(t)} be the fully unposed mesh (the pose correction blendshapes are removed from \hat{V}^{(t)}) indexed by time t≤T and let Γ={\vec{γ}^{(t)}} be the corresponding sequence of strain vectors. Also, let ε={Eᵢ}_{i≤|\vec{γ}|}∈ [symbol] ^{3N×|\vec{γ}|} denote the strain-to-skin deformation components.

As the goal is to optimize Γ and ε to match the residual animation as much as possible. At this point, an estimate of Γ is provided by the animators and muscle fiber simulation. However, since this space is completely artificial, it can be further refined in order to improve the final accuracy. Therefore both Γ and ε are computed with alternating optimization steps, one being kept constant while the other is being processed. The final convergence is reached after about 10 iterations of both steps.

Specifically, the cost function to optimize skin deformation ε is defined with two terms:

[symbol]

(ε)=Σₜ₌₁^{T}∥\tilde{V}^{(t)}−ε\vec{γ}^{(t)}∥²+μT Σₛ₌₁^{|\vec{γ}|}∥Eₛ [symbol] ₛ∥_{F}².

The first term is the reconstruction loss which computes the vertex-wise squared euclidean distance between the unposed target mesh and the strain-animated expression blendshape. The second one is a regularization term which penalizes the influence of the strains on vertices that are far away from their curves on the face. In this equation, Eₛ is to be understood as a 3×N matrix (instead of a vector in [symbol] ^{3N}) and [symbol] ₛ=diag([d_{s,1}, . . . , d_{s,N}]) ∈ [symbol] ^{N×N} denotes the vertex-wise penalty coefficient applied to the strain s. This term is important to avoid contamination, for example, a jaw muscle being correlated with the eyelids animation and giving the jaw strains a high penalty value for the eyelids' vertices prevents this.

In the alternating optimization step, ε is kept constant while fine-tuning the strain values Γ. Starting from a prior estimate, \vec{γ}ₚ^{(t)}, the following cost function is computed, which contains the same reconstruction loss as above, coupled with a regularization term that prevents the new estimate \vec{γ}^{(t)} from diverging too much from the prior estimate:

[symbol]

(Γ)=Σₜ₌₁^{T}(∥\tilde{V}^{(t)}−ε\vec{γ}^{(t)}∥²+λ∥\vec{γ}ₚ^{(t)}−\vec{γ}^{(t)}∥²).

At step 738, the strain autoencoder 705 may be trained. The autoencoder 705, or more precisely the two AE neural networks 705a-b, is trained with respect to the Euclidean L2 loss with the LAMB optimizer, an advancement of the commonly used ADAM optimizer adding layer-wise normalization of the gradient and scaling of the update step with respect to the weights to it.

To improve usability, the autoencoder may fully preserve the rest-pose strains vector \vec{γ}₀ (i.e., the strain activations when the face is in a neutral and expressionless pose). So the training process may enforce AE_{Φ}(\vec{γ}₀)=\vec{γ}₀, however, in practice, autoencoders are usually subject to slight deviations between input and output to some degree of precision. To overcome the stability issues, if g_{Φ} is the neural network, then the autoencoder is trained in the following form:

AE_{Φ}(\vec{γ})=g_{Φ}(\vec{γ})−g_{Φ}(\vec{γ}₀)+\vec{γ}₀

with respect to the cost function [symbol] (\vec{γ})=∥AE_{Φ}(\vec{γ})−\vec{γ}∥. This enforces the rest-pose stability constraint while neither hindering the training nor creating a discontinuity in \vec{γ}₀.

FIG. 7C provides a flow diagram illutrating an example process of the facial animation module 650, according to embodiments described herein. At step 742, the training process may build mesh targets. Let V̅={V̅^{(t)}}_{t≤T}∈ [symbol] ^{3N×T} be a mesh training dataset. A PCA reduction of the training data may be prepared by computing the first C=300 principal components:

Q=arg [symbol] ∥(I−X^{T}X)V̅∥.

Let P be the projection matrix from mesh space to marker space. If M is the known vector of 3D tracked facial markers, the mesh V is determined such that M=PV. This inversion is under-constrained because P is a projection (not full-ranked), hence PCA model can be used to find the best pseudo-inverse mesh Vₒₚₜ=Q^{T}Xₒₚₜ where

$$\begin{matrix}{X}_{opt} = arg {min}_{X ∈ {ℝ}^{C}} ‖ M - {PQ}^{T} X ‖ \\ = {( {PQ}^{T} )}^{- 1} M\end{matrix} .$$

(PQ^{T})⁻¹ is actually the pseudo-inverse of PQ^{T}.

In other words, the optimal controls of a blendshape model of which the shapes are the first C eigenvectors of the mesh dataset are determined. With these controls, the most plausible blendshape mesh which matches the target markers can be built. The resulting mesh Vₒₚₜ may then be used as the target for the pose and expression solvers.

At step 744, the jaw solver (e.g., 651 in FIG. 6) may be trained. As the first solving step, it aims at finding the best-matching pose vectors Θ for the given meshes. Since the eye rotations are easy to estimate from images, they are found upstream and considered known at this point. As a consequence, only the jaw poses need to be estimated. The loss which optimizes \vec{θ}^{(t)} is expressed as follows:

[symbol]

(Θ)=Σₜ₌₁^{T}(∥V̅^{(t)}−M(\vec{θ}^{(t)}, \vec{γ}₀)∥²+λ∥\vec{θ}^{(t-1)}−2\vec{θ}^{(t)}+\vec{θ}^{(t+1)}∥²).

The first term is the reconstruction loss and computes the vertex-wise euclidean distance between the ground truth mesh and the model. The second is the temporal coherency cost which computes an estimate of the second-order temporal derivative (acceleration) of the pose vector and constrains its norm to remain close to zero. This prevents jumps from one frame to the next and helps preserving the temporal coherency of the sequence (to avoid side effects at the first and last frame, data is padded by repeating these frames).

The reconstruction cost is computed with the strains input being kept constant equal to \vec{γ}₀ (corresponding to the neutral face,) which makes the expression blendshape [symbol] _{E}(\vec{γ}₀) equal to zero.

After this step, the resulting posed meshes are checked on a frame-by-frame basis and manually corrected (in the pose space) if necessary. This is done by projecting the meshes into camera space and checking that the teeth (in particular) are aligned with the ground truth camera images.

At step 746, th expression solver may be trained. This second and last step comes right after and computes the expression blendshapes inputs Γ∈ [symbol] ^{|\vec{γ}|×T} according to the following objective and with Θ now known:

[symbol]

(Γ)=Σₜ₌₁^{T}(∥V̅^{(t)}−M(\vec{θ}^{(t)}, \vec{γ}^{(t)})∥²+α∥\vec{γ}^{(t-1)}−2\vec{γ}^{(t)}+\vec{γ}^{(t+1)}∥^{2+β∥AE}_{Φ}(\vec{γ}^{(t)}, \vec{θ}^{(t)})−\vec{γ}^{(t)}∥²).

The same reconstruction term (albeit with non-constant strains now) and the acceleration cost is now applied to the strains. In addition to these, a third term may be added to prevent the strain vectors from going outside of the manifold of plausible expressions, which is defined as the space within which the autoencoder preserves its inputs.

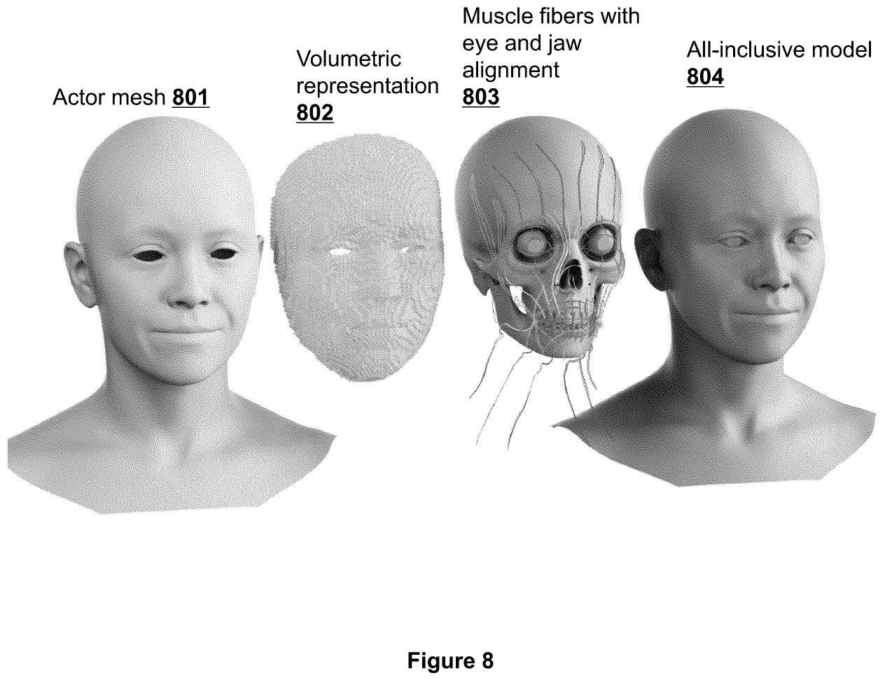

FIG. 8 is an example diagram illutrating a data example depicting an actor mesh 801, a volumetric representation 802, a representation of muscle fibers with eye and jaw alignment 803, and all-inclusive model 804 (e.g., the final M facial model 720). Specifically, the sequence of data 801-804 may be used to build the face model M 702 as described in FIG. 7 using machine learning and optimization processes trained on a significant amount of curated ground truth data.

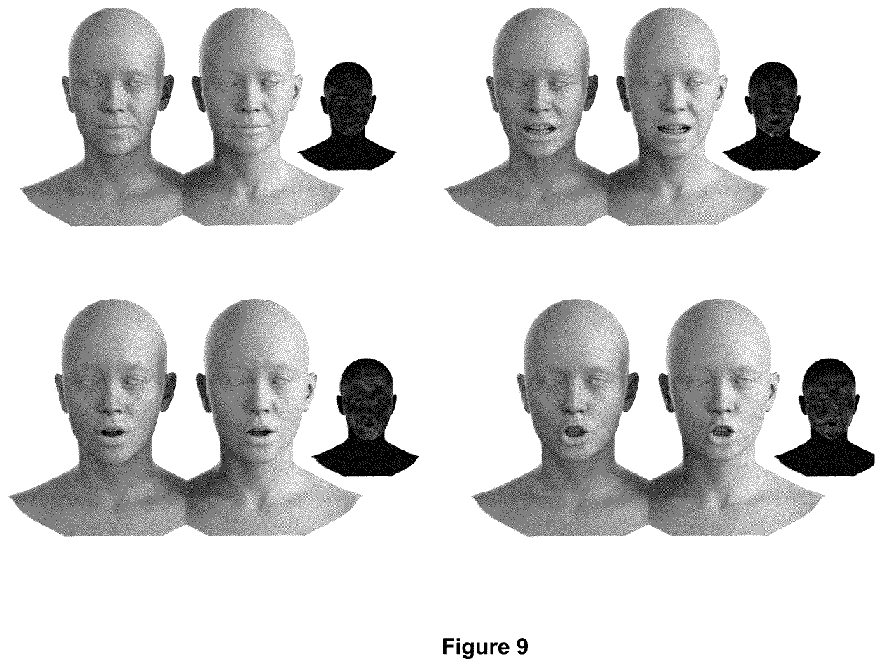

FIG. 9 is a diagram illustrating a digital representation of an actor's performance (the right head in each pair) is solved for 340 markers from validation ground-truth expressions (the left head in each pair), using the face animation pipeline 600 described in FIG. 6, according to embodiments described herein.

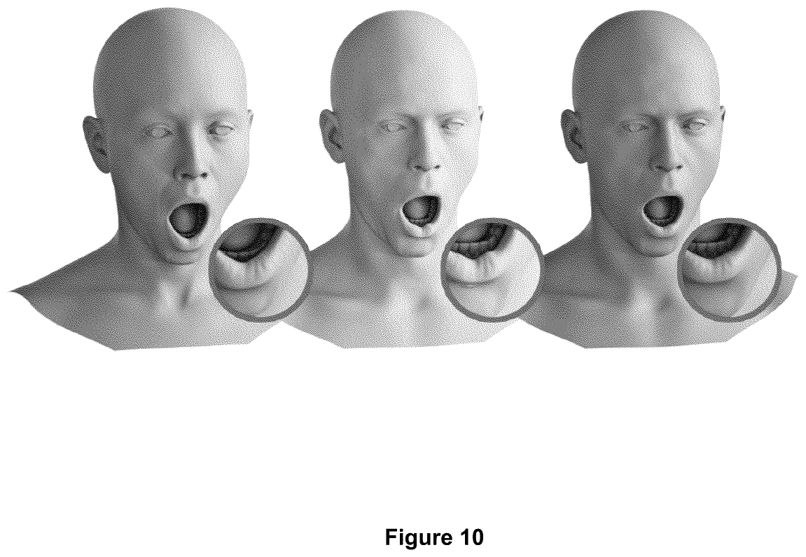

In one embodiment, to fine-tune specific expressions and increase the precision and fidelity often required by art direction, users can add a small number of guide shapes. FIG. 10 illustrates a digital representation of an actor (the left head), a representation of the character generated from processing the character without guide shapes (the center head), and a representation of the character generated from processing the character with a fixed mouth via guide shapes (the right head). Given approximately ten pairs of matching actor and character guide shapes (similar to corrective shapes), each actor scan can be expressed as a linear combination of the neutral and the guide shapes. The corresponding character shape is then refined by layering a linear combination of delta displacements computed from the character's transferred guide shapes with the same weights. Some characters might be successfully transferred using no more than twenty guide shapes.

For example, the user can add guide shapes G to correct the transfer residual error. Given pairs of actor and character guide shapes (G^{a} and G^{c}), the difference Δ with actor neutral shape R^{a} (i.e G^{a}=R^{a}+Δ^{a}) is computed and corresponding cage-transferred character shape T^{c} (G^{c}=T^{c}+Δ^{c}). Then for each scan S^{a} of the actor mesh sequence, the optimization problem may be solved:

λ^{opt}=arg min_{λ}∥S^{a}−R^{a}−ΣᵢλᵢΔᵢ^{a}∥,

where the weights λᵢ are unknown. They are then used to compute the corresponding character shape

S^{c}=T^{c}+Σᵢλᵢ^{opt}Δᵢ^{c}.

This procedure guides the transfer for extreme and critical shapes such as eye closing and jaw opening.

### Example Performance Evaluation

Strain and Latent Space Dimensions: The choice of 178 strains was an artist-curated trade-off between reconstruction accuracy, anatomic completeness and animator-control. More than 200 strains add redundant complexity for artists and less than 130 strains prevent accurate reconstruction (Fig. S7), especially around the mouth. Data experiments further includes the latent space size of autoencoders (e.g., 705), settling on half of the input size, to balance reconstruction accuracy of training data and tolerance for implausible facial expressions.

A particular 178-strain (3D) facial processing system (built upon the pipeline 600) sometimes referred to herein as an Animatomy solver, was compared against a FACS-blendshape solver (a variant of the approach shown in [Lewis]) using 200 target shapes chosen from the training data. The Animatomy solver reconstructed unseen ground-truth expressions better than the FACS-based solution, as shown by the mean-squared vertex error (maximum vertex error in parenthesis) for both models below.

| (unit: mm) | Shot 1 | Shot 2 | Shot 3 |
|---|---|---|---|
| Animatomy | 0.378 (2.751) | 0.239 (2.096) | 0.257 (2.255) |
| FACS | 0.521 (2.794) | 0.390 (2.111) | 0.490 (3.139) |

It is to be noted that the muscle strains discussed throughout the disclosure are one embodiment of the facial amination system described herein. While muscle curves provide some intuition for animators, some animators might prefer working with facial poses when quickly blocking animations from scratch. For those uses, a tool to compute strain values for posed face libraries 657 can be provided.

In some instances, an actor-rig might be trained using a single 3D scan of the actor and a large corpus of film clips of the actor. In some instances, the muscle curves can be dynamically actuated by muscle impulse. The muscle curve model might be extended beyond the chin, to extend into the neck and possibly the entire body (which might be parameterized by a typical joint skeleton). A meshCNN might be used as a network architecture to better control both spatial muscle localization and global neurological co-relation between muscles, when deforming skin.

### Computer System Environment

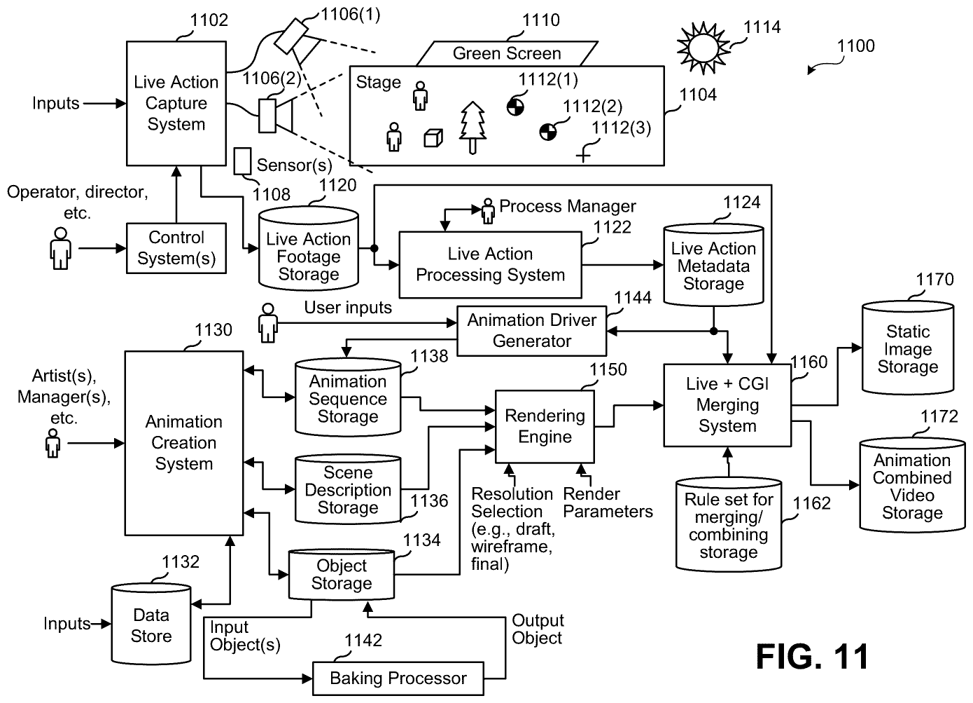

FIG. 11 illustrates an example visual content generation system 1100 as might be used to generate imagery in the form of still images and/or video sequences of images. Visual content generation system 1100 might generate imagery of live action scenes, computer generated scenes, or a combination thereof. In a practical system, users are provided with tools that allow them to specify, at high levels and low levels where necessary, what is to go into that imagery. For example, a user might be an animation artist and might use visual content generation system 1100 to capture interaction between two human actors performing live on a sound stage and replace one of the human actors with a computer-generated anthropomorphic non-human being that behaves in ways that mimic the replaced human actor's movements and mannerisms, and then add in a third computer-generated character and background scene elements that are computer-generated, all in order to tell a desired story or generate desired imagery.

Still images that are output by visual content generation system 1100 might be represented in computer memory as pixel arrays, such as a two-dimensional array of pixel color values, each associated with a pixel having a position in a two-dimensional image array. Pixel color values might be represented by three or more (or fewer) color values per pixel, such as a red value, a green value, and a blue value (e.g., in RGB format). Dimensions of such a two-dimensional array of pixel color values might correspond to a preferred and/or standard display scheme, such as 1920-pixel columns by 1280-pixel rows or 4096-pixel columns by 2160-pixel rows, or some other resolution. Images might or might not be stored in a certain structured format, but either way, a desired image may be represented as a two-dimensional array of pixel color values. In another variation, images are represented by a pair of stereo images for three-dimensional presentations and in other variations, an image output, or a portion thereof, might represent three-dimensional imagery instead of just two-dimensional views. In yet other embodiments, pixel values are data structures and a pixel value can be associated with a pixel and can be a scalar value, a vector, or another data structure associated with a corresponding pixel. That pixel value might include color values, or not, and might include depth values, alpha values, weight values, object identifiers or other pixel value components.

A stored video sequence might include a plurality of images such as the still images described above, but where each image of the plurality of images has a place in a timing sequence and the stored video sequence is arranged so that when each image is displayed in order, at a time indicated by the timing sequence, the display presents what appears to be moving and/or changing imagery. In one representation, each image of the plurality of images is a video frame having a specified frame number that corresponds to an amount of time that would elapse from when a video sequence begins playing until that specified frame is displayed. A frame rate might be used to describe how many frames of the stored video sequence are displayed per unit time. Example video sequences might include 24 frames per second (24 FPS), 50 FPS, 140 FPS, or other frame rates. In some embodiments, frames are interlaced or otherwise presented for display, but for clarity of description, in some examples, it is assumed that a video frame has one specified display time, but other variations might be contemplated.

One method of creating a video sequence is to simply use a video camera to record a live action scene, i.e., events that physically occur and can be recorded by a video camera. The events being recorded can be events to be interpreted as viewed (such as seeing two human actors talk to each other) and/or can include events to be interpreted differently due to clever camera operations (such as moving actors about a stage to make one appear larger than the other despite the actors actually being of similar build, or using miniature objects with other miniature objects so as to be interpreted as a scene containing life-sized objects).

Creating video sequences for story-telling or other purposes often calls for scenes that cannot be created with live actors, such as a talking tree, an anthropomorphic object, space battles, and the like. Such video sequences might be generated computationally rather than capturing light from live scenes. In some instances, an entirety of a video sequence might be generated computationally, as in the case of a computer-animated feature film. In some video sequences, it is desirable to have some computer-generated imagery and some live action, perhaps with some careful merging of the two.

While computer-generated imagery might be creatable by manually specifying each color value for each pixel in each frame, this is likely too tedious to be practical. As a result, a creator uses various tools to specify the imagery at a higher level. As an example, an artist might specify the positions in a scene space, such as a three-dimensional coordinate system, of objects and/or lighting, as well as a camera viewpoint, and a camera view plane. From that, a rendering engine could take all of those as inputs, and compute each of the pixel color values in each of the frames. In another example, an artist specifies position and movement of an articulated object having some specified texture rather than specifying the color of each pixel representing that articulated object in each frame.

In a specific example, a rendering engine performs ray tracing wherein a pixel color value is determined by computing which objects lie along a ray traced in the scene space from the camera viewpoint through a point or portion of the camera view plane that corresponds to that pixel. For example, a camera view plane might be represented as a rectangle having a position in the scene space that is divided into a grid corresponding to the pixels of the ultimate image to be generated, and if a ray defined by the camera viewpoint in the scene space and a given pixel in that grid first intersects a solid, opaque, blue object, that given pixel is assigned the color blue. Of course, for modern computer-generated imagery, determining pixel colors—and thereby generating imagery—can be more complicated, as there are lighting issues, reflections, interpolations, and other considerations.

As illustrated in FIG. 11, a live action capture system 1102 captures a live scene that plays out on a stage 1104. Live action capture system 1102 is described herein in greater detail, but might include computer processing capabilities, image processing capabilities, one or more processors, program code storage for storing program instructions executable by the one or more processors, as well as user input devices and user output devices, not all of which are shown.

In a specific live action capture system, cameras 1106(1) and 1106(2) capture the scene, while in some systems, there might be other sensor(s) 1108 that capture information from the live scene (e.g., infrared cameras, infrared sensors, motion capture (“mo-cap”) detectors, etc.). On stage 1104, there might be human actors, animal actors, inanimate objects, background objects, and possibly an object such as a green screen 1110 that is designed to be captured in a live scene recording in such a way that it is easily overlaid with computer-generated imagery. Stage 1104 might also contain objects that serve as fiducials, such as fiducials 1112(1)-(3), that might be used post-capture to determine where an object was during capture. A live action scene might be illuminated by one or more lights, such as an overhead light 1114.

During or following the capture of a live action scene, live action capture system 1102 might output live action footage to a live action footage storage 1120. A live action processing system 1122 might process live action footage to generate data about that live action footage and store that data into a live action metadata storage 1124. Live action processing system 1122 might include computer processing capabilities, image processing capabilities, one or more processors, program code storage for storing program instructions executable by the one or more processors, as well as user input devices and user output devices, not all of which are shown. Live action processing system 1122 might process live action footage to determine boundaries of objects in a frame or multiple frames, determine locations of objects in a live action scene, where a camera was relative to some action, distances between moving objects and fiducials, etc. Where elements have sensors attached to them or are detected, the metadata might include location, color, and intensity of overhead light 1114, as that might be useful in post-processing to match computer-generated lighting on objects that are computer-generated and overlaid on the live action footage. Live action processing system 1122 might operate autonomously, perhaps based on predetermined program instructions, to generate and output the live action metadata upon receiving and inputting the live action footage. The live action footage can be camera-captured data as well as data from other sensors.

An animation creation system 1130 is another part of visual content generation system 1100. Animation creation system 1130 might include computer processing capabilities, image processing capabilities, one or more processors, program code storage for storing program instructions executable by the one or more processors, as well as user input devices and user output devices, not all of which are shown. Animation creation system 1130 might be used by animation artists, managers, and others to specify details, perhaps programmatically and/or interactively, of imagery to be generated. From user input and data from a database or other data source, indicated as a data store 1132, animation creation system 1130 might generate and output data representing objects (e.g., a horse, a human, a ball, a teapot, a cloud, a light source, a texture, etc.) to an object storage 1134, generate and output data representing a scene into a scene description storage 1136, and/or generate and output data representing animation sequences to an animation sequence storage 1138.

Scene data might indicate locations of objects and other visual elements, values of their parameters, lighting, camera location, camera view plane, and other details that a rendering engine 1150 might use to render CGI imagery. For example, scene data might include the locations of several articulated characters, background objects, lighting, etc. specified in a two-dimensional space, three-dimensional space, or other dimensional space (such as a 2.5-dimensional space, three-quarter dimensions, pseudo-3D spaces, etc.) along with locations of a camera viewpoint and view place from which to render imagery. For example, scene data might indicate that there is to be a red, fuzzy, talking dog in the right half of a video and a stationary tree in the left half of the video, all illuminated by a bright point light source that is above and behind the camera viewpoint. In some cases, the camera viewpoint is not explicit, but can be determined from a viewing frustum. In the case of imagery that is to be rendered to a rectangular view, the frustum would be a truncated pyramid. Other shapes for a rendered view are possible and the camera view plane could be different for different shapes.

Animation creation system 1130 might be interactive, allowing a user to read in animation sequences, scene descriptions, object details, etc. and edit those, possibly returning them to storage to update or replace existing data. As an example, an operator might read in objects from object storage into a baking processor 1142 that would transform those objects into simpler forms and return those to object storage 1134 as new or different objects. For example, an operator might read in an object that has dozens of specified parameters (movable joints, color options, textures, etc.), select some values for those parameters and then save a baked object that is a simplified object with now fixed values for those parameters.

Rather than requiring user specification of each detail of a scene, data from data store 1132 might be used to drive object presentation. For example, if an artist is creating an animation of a spaceship passing over the surface of the Earth, instead of manually drawing or specifying a coastline, the artist might specify that animation creation system 1130 is to read data from data store 1132 in a file containing coordinates of Earth coastlines and generate background elements of a scene using that coastline data.

Animation sequence data might be in the form of time series of data for control points of an object that has attributes that are controllable. For example, an object might be a humanoid character with limbs and joints that are movable in manners similar to typical human movements. An artist can specify an animation sequence at a high level, such as “the left hand moves from location (X1, Y1, Z1) to (X2, Y2, Z2) over time T1 to T2”, at a lower level (e.g., “move the elbow joint 2.5 degrees per frame”) or even at a very high level (e.g., “character A should move, consistent with the laws of physics that are given for this scene, from point P1 to point P2 along a specified path”).

Animation sequences in an animated scene might be specified by what happens in a live action scene. An animation driver generator 1144 might read in live action metadata, such as data representing movements and positions of body parts of a live actor during a live action scene. Animation driver generator 1144 might generate corresponding animation parameters to be stored in animation sequence storage 1138 for use in animating a CGI object. This can be useful where a live action scene of a human actor is captured while wearing mo-cap fiducials (e.g., high-contrast markers outside actor clothing, high-visibility paint on actor skin, face, etc.) and the movement of those fiducials is determined by live action processing system 1122. Animation driver generator 1144 might convert that movement data into specifications of how joints of an articulated CGI character are to move over time.

A rendering engine 1150 can read in animation sequences, scene descriptions, and object details, as well as rendering engine control inputs, such as a resolution selection and a set of rendering parameters. Resolution selection might be useful for an operator to control a trade-off between speed of rendering and clarity of detail, as speed might be more important than clarity for a movie maker to test some interaction or direction, while clarity might be more important than speed for a movie maker to generate data that will be used for final prints of feature films to be distributed. Rendering engine 1150 might include computer processing capabilities, image processing capabilities, one or more processors, program code storage for storing program instructions executable by the one or more processors, as well as user input devices and user output devices, not all of which are shown.

Visual content generation system 1100 can also include a merging system 1160 that merges live footage with animated content. The live footage might be obtained and input by reading from live action footage storage 1120 to obtain live action footage, by reading from live action metadata storage 1124 to obtain details such as presumed segmentation in captured images segmenting objects in a live action scene from their background (perhaps aided by the fact that green screen 1110 was part of the live action scene), and by obtaining CGI imagery from rendering engine 1150.

A merging system 1160 might also read data from rulesets for merging/combining storage 1162. A very simple example of a rule in a ruleset might be “obtain a full image including a two-dimensional pixel array from live footage, obtain a full image including a two-dimensional pixel array from rendering engine 1150, and output an image where each pixel is a corresponding pixel from rendering engine 1150 when the corresponding pixel in the live footage is a specific color of green, otherwise output a pixel value from the corresponding pixel in the live footage.”

Merging system 1160 might include computer processing capabilities, image processing capabilities, one or more processors, program code storage for storing program instructions executable by the one or more processors, as well as user input devices and user output devices, not all of which are shown. Merging system 1160 might operate autonomously, following programming instructions, or might have a user interface or programmatic interface over which an operator can control a merging process. In some embodiments, an operator can specify parameter values to use in a merging process and/or might specify specific tweaks to be made to an output of merging system 1160, such as modifying boundaries of segmented objects, inserting blurs to smooth out imperfections, or adding other effects. Based on its inputs, merging system 1160 can output an image to be stored in a static image storage 1170 and/or a sequence of images in the form of video to be stored in an animated/combined video storage 1172.

Thus, as described, visual content generation system 1100 can be used to generate video that combines live action with computer-generated animation using various components and tools, some of which are described in more detail herein. While visual content generation system 1100 might be useful for such combinations, with suitable settings, it can be used for outputting entirely live action footage or entirely CGI sequences. The code may also be provided and/or carried by a transitory computer readable medium, e.g., a transmission medium such as in the form of a signal transmitted over a network.

According to one embodiment, the techniques described herein are implemented by one or more generalized computing systems programmed to perform the techniques pursuant to program instructions in firmware, memory, other storage, or a combination. Special-purpose computing devices may be used, such as desktop computer systems, portable computer systems, handheld devices, networking devices or any other device that incorporates hard-wired and/or program logic to implement the techniques.

One embodiment might include a carrier medium carrying image data or other data having details generated using the methods described herein. The carrier medium can comprise any medium suitable for carrying the image data or other data, including a storage medium, e.g., solid-state memory, an optical disk or a magnetic disk, or a transient medium, e.g., a signal carrying the image data such as a signal transmitted over a network, a digital signal, a radio frequency signal, an acoustic signal, an optical signal or an electrical signal.

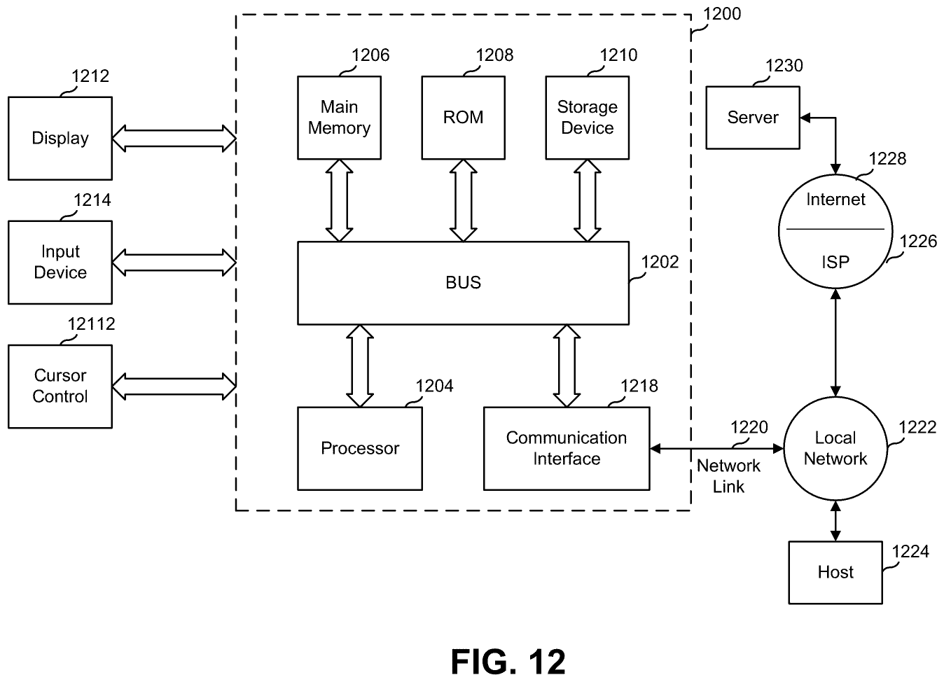

FIG. 12 is a block diagram that illustrates a computer system 1200 upon which the computer systems of the systems described herein and/or visual content generation system 1100 (see FIG. 11) may be implemented. Computer system 1200 includes a bus 1202 or other communication mechanism for communicating information, and a processor 1204 coupled with bus 1202 for processing information. Processor 1204 may be, for example, a general-purpose microprocessor.

Computer system 1200 also includes a main memory 1206, such as a random-access memory (RAM) or other dynamic storage device, coupled to bus 1202 for storing information and instructions to be executed by processor 1204. Main memory 1206 may also be used for storing temporary variables or other intermediate information during execution of instructions to be executed by processor 1204. Such instructions, when stored in non-transitory storage media accessible to processor 1204, render computer system 1200 into a special-purpose machine that is customized to perform the operations specified in the instructions.

Computer system 1200 further includes a read only memory (ROM) 1208 or other static storage device coupled to bus 1202 for storing static information and instructions for processor 1204. A storage device 1210, such as a magnetic disk or optical disk, is provided and coupled to bus 1202 for storing information and instructions.

Computer system 1200 may be coupled via bus 1202 to a display 1212, such as a computer monitor, for displaying information to a computer user. An input device 1214, including alphanumeric and other keys, is coupled to bus 1202 for communicating information and command selections to processor 1204. Another type of user input device is a cursor control 1216, such as a mouse, a trackball, or cursor direction keys for communicating direction information and command selections to processor 1204 and for controlling cursor movement on display 1212. This input device typically has two degrees of freedom in two axes, a first axis (e.g., x) and a second axis (e.g., y), that allows the device to specify positions in a plane.

Computer system 1200 may implement the techniques described herein using customized hard-wired logic, one or more ASICs or FPGAs, firmware and/or program logic which in combination with the computer system causes or programs computer system 1200 to be a special-purpose machine. According to one embodiment, the techniques herein are performed by computer system 1200 in response to processor 1204 executing one or more sequences of one or more instructions contained in main memory 1206. Such instructions may be read into main memory 1206 from another storage medium, such as storage device 1210. Execution of the sequences of instructions contained in main memory 1206 causes processor 1204 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may include non-volatile media and/or volatile media. Non-volatile media includes, for example, optical or magnetic disks, such as storage device 1210. Volatile media includes dynamic memory, such as main memory 1206. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire, and fiber optics, including the wires that include bus 1202. Transmission media can also take the form of acoustic or light waves, such as those generated during radio-wave and infra-red data communications.

Various forms of media may be involved in carrying one or more sequences of one or more instructions to processor 1204 for execution. For example, the instructions may initially be carried on a magnetic disk or solid-state drive of a remote computer. The remote computer can load the instructions into its dynamic memory and send the instructions over a network connection. A modem or network interface local to computer system 1200 can receive the data. Bus 1202 carries the data to main memory 1206, from which processor 1204 retrieves and executes the instructions. The instructions received by main memory 1206 may optionally be stored on storage device 1210 either before or after execution by processor 1204.

Computer system 1200 also includes a communication interface 1218 coupled to bus 1202. Communication interface 1218 provides a two-way data communication coupling to a network link 1220 that is connected to a local network 1222. For example, communication interface 1218 may be a network card, a modem, a cable modem, or a satellite modem to provide a data communication connection to a corresponding type of telephone line or communications line. Wireless links may also be implemented. In any such implementation, communication interface 1218 sends and receives electrical, electromagnetic, or optical signals that carry digital data streams representing various types of information.

Network link 1220 typically provides data communication through one or more networks to other data devices. For example, network link 1220 may provide a connection through local network 1222 to a host computer 1224 or to data equipment operated by an Internet Service Provider (ISP) 1226. ISP 1226 in turn provides data communication services through the world-wide packet data communication network now commonly referred to as the “Internet” 1228. Local network 1222 and Internet 1228 both use electrical, electromagnetic, or optical signals that carry digital data streams. The signals through the various networks and the signals on network link 1220 and through communication interface 1218, which carry the digital data to and from computer system 1200, are example forms of transmission media.

Computer system 1200 can send messages and receive data, including program code, through the network(s), network link 1220, and communication interface 1218. In the Internet example, a server 1230 might transmit a requested code for an application program through the Internet 1228, ISP 1226, local network 1222, and communication interface 1218. The received code may be executed by processor 1204 as it is received, and/or stored in storage device 1210, or other non-volatile storage for later execution.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory. The code may also be provided carried by a transitory computer readable medium e.g., a transmission medium such as in the form of a signal transmitted over a network.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

The use of examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Further embodiments can be envisioned to one of ordinary skill in the art after reading this disclosure. In other embodiments, combinations or sub-combinations of the above-disclosed invention can be advantageously made. The example arrangements of components are shown for purposes of illustration and combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

All references, including publications, patent applications, and patents, cited herein are hereby incorporated by reference to the same extent as if each reference were individually and specifically indicated to be incorporated by reference and were set forth in its entirety herein.

What is claimed is:

1. A computer-implemented method for facial animation of a character face using actor data captured from a human actor, the method comprising:
receiving data associated with a plurality of facial scans of an actor over a first plurality of facial expression poses;
computing, from the received data, a plurality of strain values corresponding to a plurality of facial muscle fiber curves given the first plurality of facial expression poses;
encoding, by an autoencoder, the plurality of strain values into a strain vector;
transforming, via a fully connected layer representing a strain-to-skin deformation matrix, the strain vector to a skin expression;
generating an actor mesh based on the skin expression, the strain vector and corresponding strain-to-skin deformation data;
training a neural network based shape transfer model for transferring the actor mesh to a character mesh using a dataset comprising the plurality of strain values and/or the strain vector, the skin expression corresponding to the actor and character skin expressions; and
generating, using the trained neural network based shape transfer model and the character mesh, an animated character facial expression pose from the strain vector corresponding to an actor facial expression pose.

2. The method of claim 1, further comprising:
dividing the plurality of strain values into a first portion of strain values corresponding to a lower region on an actor face and a second portion of strain values corresponding to an upper region on the actor face;
encoding, by a first autoencoder, the first portion of strain values into a first strain vector;
encoding, by a second autoencoder, the second portion of strain values into a second strain vector; and
concatenating the first strain vector and the second strain vector into the strain vector.

3. The method of claim 1, further comprising:
transforming a pose vector corresponding to jaw and eyeball control corresponding to the strain vector to a vector containing concatenated elements of an eyeball transformation matrix and a jaw transformation matrix.

4. The method of claim 1, wherein the training the neural network based shape transfer model comprises:
updating model weights corresponding to eye and jaw regions and deformation matrices based on a cost function computed from a ground truth mesh, a rest-pose mesh, joint locations, and a pose vector;
updating model weights further based on pose correction blendshapes;
updating the strain-to-skin deformation matrix based on a loss computed from the rest-pose mesh and the actor mesh; and
training the autoencoder by enforcing the autoencoder to preserve a rest-pose strain vector.

5. The method of claim 1, further comprising:
building a mesh training dataset of one or more mesh targets;
training a jaw solver that optimizes a pose vector for a given mesh; and
training an expression solver based on a loss computed based at least in part on a ground-truth mesh and the actor mesh.

6. The method of claim 5, wherein generating, using the trained neural network based shape transfer model, the animated character facial expression pose comprises:
performing, using the jaw solver, eyes and jaws alignment by solving mandible movement.

7. The method of claim 5, wherein generating, using the trained neural network based shape transfer model, the animated character facial expression pose comprises:
reconstructing, using the trained expression solver, the skin expression corresponding to the actor; and
transforming the skin expression corresponding to the actor to the animated character facial expression pose.

8. The method of claim 1, further comprising:
providing an editing tool interface at which a user manually edits the animated character facial expression pose.

9. The method of claim 8, wherein the editing tool interface include a brush element that allows a user to contract or elongate a muscle curve via a movement of the brush element.

10. A system for facial animation of a character face using actor data captured from a human actor, the system comprising:
a communication interface that receives data associated with a plurality of facial scans of an actor over a first plurality of facial expression poses;
a memory storing a plurality of processor-executable instructions; and
one or more processors reading and executing the plurality of processor-executable instructions to perform operations including:
computing, from the received data, a plurality of strain values corresponding to a plurality of facial muscle fiber curves given the first plurality of facial expression poses;
encoding, by an autoencoder, the plurality of strain values into a strain vector;
transforming, via a fully connected layer representing a strain-to-skin deformation matrix, the strain vector to a skin expression;
generating an actor mesh based on the skin expression, the strain vector and corresponding strain-to-skin deformation data;
training a neural network based shape transfer model for transferring the actor mesh to a character mesh using a dataset comprising the plurality of strain values and/or the strain vector, the skin expression corresponding to the actor and character skin expressions; and
generating, using the trained neural network based shape transfer model and the character mesh, an animated character facial expression pose from the strain vector corresponding to an actor facial expression pose.

11. The system of claim 10, wherein the operations further comprise:
dividing the plurality of strain values into a first portion of strain values corresponding to a lower region on an actor face and a second portion of strain values corresponding to an upper region on the actor face;
encoding, by a first autoencoder, the first portion of strain values into a first strain vector;
encoding, by a second autoencoder, the second portion of strain values into a second strain vector; and
concatenating the first strain vector and the second strain vector into the strain vector.

12. The system of claim 10, wherein the operations further comprise:
transforming a pose vector corresponding to jaw and eyeball control corresponding to the strain vector to a vector containing concatenated elements of an eyeball transformation matrix and a jaw transformation matrix.

13. The system of claim 10, wherein an operation of training the neural network based shape transfer model comprises:
updating model weights corresponding to eye and jaw regions and deformation matrices based on a cost function computed from a ground truth mesh, a rest-pose mesh, joint locations, and a pose vector;
updating model weights further based on pose correction blendshapes;
updating the strain-to-skin deformation matrix based on a loss computed from the rest-pose mesh and the actor mesh; and
training the autoencoder by enforcing the autoencoder to preserve a rest-pose strain vector.

14. The system of claim 10, wherein the operations further comprise:
building a mesh training dataset of one or more mesh targets;
training a jaw solver that optimizes a pose vector for a given mesh; and
training an expression solver based on a loss computed based at least in part on a ground-truth mesh and the actor mesh.

15. The system of claim 14, wherein an operation of generating, using the trained neural network based shape transfer model, the animated character facial expression pose comprises:
performing, using the jaw solver, eyes and jaws alignment by solving mandible movement.

16. The system of claim 14, wherein an operation of generating, using the trained neural network based shape transfer model, the animated character facial expression pose comprises:
reconstructing, using the trained expression solver, the skin expression corresponding to the actor; and
transforming the skin expression corresponding to the actor to the animated character facial expression pose.

17. The system of claim 10, wherein the operations further comprise:
providing an editing tool interface at which a user manually edits the animated character facial expression pose.

18. The system of claim 17, wherein the editing tool interface include a brush element that allows a user to contract or elongate a muscle curve via a movement of the brush element.

19. A non-transitory processor-readable storage medium storing a plurality of processor-executable instructions for facial animation of a character face using actor data captured from a human actor, the instructions being executed by one or more processors to perform operations comprising:
receiving data associated with a plurality of facial scans of an actor over a first plurality of facial expression poses;
computing, from the received data, a plurality of strain values corresponding to a plurality of facial muscle fiber curves given the first plurality of facial expression poses;
encoding, by an autoencoder, the plurality of strain values into a strain vector;
transforming, via a fully connected layer representing a strain-to-skin deformation matrix, the strain vector to a skin expression;
generating an actor mesh based on the skin expression, the strain vector and corresponding strain-to-skin deformation data;
training a neural network based shape transfer model for transferring the actor mesh to a character mesh using a dataset comprising the plurality of strain values and/or the strain vector, the skin expression corresponding to the actor and character skin expressions; and
generating, using the trained neural network based shape transfer model and the character mesh, an animated character facial expression pose from the strain vector corresponding to an actor facial expression pose.

20. The non-transitory processor-readable storage medium of claim 19, wherein the operations further comprise:
dividing the plurality of strain values into a first portion of strain values corresponding to a lower region on an actor face and a second portion of strain values corresponding to an upper region on the actor face;
encoding, by a first autoencoder, the first portion of strain values into a first strain vector;
encoding, by a second autoencoder, the second portion of strain values into a second strain vector; and
concatenating the first strain vector and the second strain vector into the strain vector; and
transforming a pose vector corresponding to jaw and eyeball control corresponding to the strain vector to a vector containing concatenated elements of an eyeball transformation matrix and a jaw transformation matrix.
